(19) United States
(12) Patent Application Publication
(10) Pub. No.: US 2010/0171855 A1
(43) Pub. Date: Jul. 8, 2010

(54) METHOD FOR DRIVING SOLID-STATE IMAGING DEVICE, AND SOLID-STATE IMAGING DEVICE

(75) Inventors: Toshifumi Habara, Osaka (JP); Junji Tokumoto, Osaka (JP); Takeshi Fujita, Kyoto (JP); Kazuya Yonemoto, Osaka (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/663,968

(22) PCT Filed: May 20, 2008
(86) PCT No.: PCT/JP2008/001254

§ 371 Date: Dec. 10, 2009

(30) Foreign Application Priority Data
Jun. 14, 2007 (JP) 2007-158025

(51) Int. Cl. H04N 5/335

(52) U.S. Cl. 348/294; 348/E05.091

(57) ABSTRACT

The present invention has an object of providing a method for driving a solid-state imaging device which includes photodiodes 210 arranged in columns and rows and vertical CCDs 220 each of which is provided for a corresponding one of the columns of the photodiodes and includes transfer electrodes V1 to V6, the method for driving the solid-state imaging device making it possible to reduce aged deterioration of a vertical CCD and a reading voltage and including: reading a signal charge from each of the photodiodes 210 by setting an electric potential of one of the transfer electrodes to a high-level electric potential V_{H}; and transferring, in a column direction, the read signal charge by applying, to each of the transfer electrodes V1 to V6, a driving pulse having a mid-level electric potential V_{M} and a low-level electric potential V_{L}, the mid-level electric potential V_{M} being lower than the electric potential V_{H}, and the low-level electric potential V_{L} being lower than the electric potential V_{M}, wherein, in the reading, while the electric potential V_{H} is being applied, an electric potential of a transfer electrode that is adjacent to the transfer electrode having the electric potential V_{H} is set to the electric potential V_{M}, and an electric potential of a transfer electrode that is not adjacent to the transfer electrode having the electric potential V_{H} is changed.

### TECHNICAL FIELD

The present invention relates to a method for driving a solid-state imaging device, and in particular to a method for transferring a signal charge in a vertical CCD.

### BACKGROUND ART

Generally, a CCD (Charge Coupled Device) solid-state imaging device has been used for a solid-state imaging device included in an imaging apparatus such as a video camera and a digital still camera. In the CCD solid-state imaging device, signal charges generated using incident light in photodiodes are read to a vertical CCD, and the read signal charges are transferred to a charge detecting unit (FD unit) by the vertical CCD and a horizontal CCD.

When it is attempted that power consumption is reduced in such a CCD solid-state imaging device by lowering reading voltages from the photodiodes to the vertical CCD, a problem as shown in FIG. 1 occurs. To put it differently, when a reading voltage φV1 to be applied to a transfer electrode 523C is lower, a variation in electric potential (GND≧variation in positive direction) of a channel stop 528 is significantly influenced and a portion of a signal charge accumulated in a photodiode 524 is not read into a vertical CCD 525, which causes a reading residue of the signal charge. Patent Reference 1 discloses a method for driving a solid-state imaging device as a technique for solving such a problem.

In the method, when the reading voltage φV1 is applied to the transfer electrode 523C, a reverse-modulated pulse that is transited to a reverse polarity with respect to the reading voltage φV1 is applied to a transfer electrode adjacent to the transfer electrode 523C. With this, since the influence on the variation in electric potential of the channel stop 528 below the transfer electrode 523C can be suppressed as shown in FIG. 2, the reading residue of the signal charge of the photodiode 524 can be prevented from occurring. Patent Reference 1: Japanese Unexamined Patent Application Publication No. 7-322143

### DISCLOSURE OF THE INVENTION

### Problems that the Invention is to Solve

In the method for driving the solid-state imaging device disclosed by Patent Reference 1, however, applying the reverse-modulated pulse to the transfer electrode adjacent to the transfer electrode 523C causes a large difference in voltage between the transfer electrode 523C and the adjacent transfer electrode.

Thus, an avalanche breakdown occurs and a high electric field is produced on a silicon substrate on which the photodiode 524 and the vertical CCD 525 are formed. As a result, a portion of a signal charge to be generated is driven into a gate insulator film, which causes a nonuniform electric potential to be generated in the vertical CCD 525, and a new problem, aged deterioration in transfer efficiency and reading efficiency of the vertical CCD, occurs.

In view of the above problems, the present invention has an object of providing a method for driving a solid-state imaging device which can suppress the aged deterioration of the vertical CCD and reduce the reading voltage.

### Means to Solve the Problems

In order to achieve the above object, a method for driving a solid-state imaging device according to an aspect of the present invention is a method for driving a solid-state imaging device which includes photodiodes arranged in columns and rows and vertical transfer units each of which is provided for a corresponding one of the columns of the photodiodes and includes transfer electrodes, the method includes: reading a signal charge from each of the photodiodes by setting an electric potential of one of the transfer electrodes to a first electric potential; and transferring, in a column direction, the read signal charge by applying, to each of the transfer electrodes, a driving pulse having a second electric potential and a third electric potential, the second electric potential being lower than the first electric potential, and the third electric potential being lower than the second electric potential, wherein, in the reading, while the first electric potential is being applied, an electric potential of a transfer electrode that is adjacent to the transfer electrode having the first electric potential is set to the second electric potential, and an electric potential of a transfer electrode that is not adjacent to the transfer electrode having the first electric potential is changed either from the second electric potential to the third electric potential or from the third electric potential to the second electric potential. Here, in the reading, while the signal charge is being read, an electric potential of a transfer electrode that is not adjacent to the transfer electrode having the first electric potential may be changed to an electric potential having a reverse polarity with respect to the first electric potential.

Accordingly, when the signal charge of each photodiode is read, not the third electric potential but the second electric potential is applied to the transfer electrode that is adjacent to the transfer electrode to which the first electric potential, that is, a reading voltage is applied, the second electric potential being higher than the third electric potential. Therefore, since the method for driving the solid-state imaging device can reduce the difference in electric potentials between the adjacent transfer electrodes more than the method disclosed by Patent Reference 1, it is possible to suppress the aged deterioration of the vertical CCD.

In addition, it is possible to suppress an influence on a variation in electric potential under the transfer electrode to which the reading voltage is applied, and a potential shape below the transfer electrode is further changed into a large slope gradually sloping downward from the photodiode to the transfer electrode. As a result, since a reading residue when reading the signal charge of the photodiode is prevented from occurring, it is possible to reduce the reading voltage.

Furthermore, wiring that provides the driving pulse to each transfer electrode may have a shunt wiring structure.

This makes it possible to achieve high-speed transfer of signal charges.

Moreover, the transfer electrode having the first electric potential may have a larger area than the transfer electrode that is adjacent to the transfer electrode having the first electric potential.

Accordingly, an area of a transfer electrode which is provided on a reading path of the signal charge of the photodiode and to which the reading voltage for reading the signal charge of the photodiode is applied becomes larger. Consequently, even when pixels are miniaturized, it is possible to ensure a reading channel width necessary for reading the signal charge.

Furthermore, in the transferring, a five- or more phase driving pulse may be applied to each transfer electrode.

Thus, even when the pixels are miniaturized along with miniaturization of a solid-state imaging device and a capability for transferring the signal charge is reduced, a sufficient transfer capability can be ensured, and it is possible to achieve a balance between the miniaturization of the solid-state imaging device and enhancement of image characteristics such as sensitivity characteristics, smear characteristics, and saturation characteristics.

Moreover, in the reading, electric potentials of two transfer electrodes that are not adjacent to the transfer electrode having the first electric potential may be changed while the signal charge is being read. Furthermore, in the reading, the electric potentials of the two transfer electrodes that are not adjacent to the transfer electrode having the first electric potential are concurrently changed into a reverse polarity with respect to the first electric potential while the signal charge is being read.

Accordingly, the potential shape below the transfer electrode is changed into the large slope gradually sloping downward from the photodiode to the transfer electrode. As a result, since the reading residue of the signal charge of the photodiode is highly likely to be prevented from occurring, it is possible to significantly reduce the reading voltage.

Moreover, in the reading, an electric potential of a predetermined transfer electrode that is not adjacent to the transfer electrode having the first electric potential may be changed two times while the signal charge is being read.

In addition, since the electric potential of the transfer electrode is changed and then the changed electric potential can be restored, it is possible to significantly reduce the reading voltage without sacrificing the transfer capability.

Furthermore, another aspect of the present invention can be a solid-state imaging device which includes: photodiodes arranged in columns and rows; vertical transfer units each of which is provided for a corresponding one of the columns of the photodiodes and includes transfer electrodes; and a transfer control unit configured to: read a signal charge from each of the photodiodes by setting an electric potential of one of the transfer electrodes to a first electric potential; transfer, in a column direction, the read signal charge by applying, to each of the transfer electrodes, a driving pulse having a second electric potential and a third electric potential; and, in the reading of the signal charge, while the first electric potential is being applied, set an electric potential of a transfer electrode that is adjacent to the transfer electrode having the first electric potential, to the second electric potential, and change, either from the second electric potential to the third electric potential or from the third electric potential to the second electric potential, an electric potential of a transfer electrode that is not adjacent to the transfer electrode having the first electric potential, the second electric potential being lower than the first electric potential, and the third electric potential being lower than the second electric potential.

Accordingly, it is possible to reduce the aged deterioration in the transfer efficiency for signal charge and the reading voltage.

### Effects of the Invention

The present invention can reduce the aged deterioration in the transfer efficiency for signal charge and the reading voltage.

### BRIEF DESCRIPTION OF THE DRAWINGS

FIG. 1 is a diagram showing a reading residue of a signal charge.

FIG. 2 is a diagram showing a signal charge reading method according to the method for driving the solid-state imaging device disclosed by Patent Reference 1.

FIG. 3 is a diagram showing a schematic structure of a solid-state imaging device according to Embodiment 1 of the present invention.

FIG. 4 is a diagram showing a detailed structure of a solid-state image sensor according to Embodiment 1.

FIG. 5 is a top view showing an electrode structure of a vertical CCD according to Embodiment 1.

FIG. 6A is a timing diagram showing a method for transferring a signal charge in the vertical CCD according to Embodiment 1.

FIG. 6B is a charge transfer conceptual diagram showing the method for transferring the signal charge in the vertical CCD according to Embodiment 1.

FIG. 6C is a potential distribution variation diagram showing the method for transferring the signal charge in the vertical CCD according to Embodiment 1.

FIG. 7A is a timing diagram showing signal charge mixture in the vertical CCD according to Embodiment 1.

FIG. 7B is a charge mixture transfer conceptual diagram showing signal charge mixture in the vertical CCD according to Embodiment 1.

FIG. 7C is a potential distribution variation diagram showing signal charge mixture in the vertical CCD according to Embodiment 1.

FIG. 7D is a potential distribution variation diagram showing signal charge mixture in the vertical CCD according to Embodiment 1.

FIG. 8A is a timing diagram showing a modification of the method for transferring the signal charge in the vertical CCD according to Embodiment 1.

FIG. 8B is a charge transfer conceptual diagram showing a modification of the method for transferring the signal charge in the vertical CCD according to Embodiment 1.

FIG. 8C is a potential distribution variation diagram showing a modification of the method for transferring the signal charge in the vertical CCD according to Embodiment 1.

FIG. 9A is a timing diagram showing a modification of the method for transferring the signal charge in the vertical CCD according to Embodiment 1.

FIG. 9B is a charge transfer conceptual diagram showing a modification of the method for transferring the signal charge in the vertical CCD according to Embodiment 1.

FIG. 9C is a potential distribution variation diagram showing a modification of the method for transferring the signal charge in the vertical CCD according to Embodiment 1.

FIG. 10A is a timing diagram showing a modification of the method for transferring the signal charge in the vertical CCD according to Embodiment 1.

FIG. 10B is a charge transfer conceptual diagram showing a modification of the method for transferring the signal charge in the vertical CCD according to Embodiment 1.

FIG. 10C is a potential distribution variation diagram showing a modification of the method for transferring the signal charge in the vertical CCD according to Embodiment 1.

FIG. 11 is a top view showing a structure of a solid-state imaging device (solid-state image sensor) according to Embodiment 2 of the present invention.

FIG. 12A is a cross section view (cross section view along the line A-A′ in FIG. 11) of the solid-state image sensor according to Embodiment 2.

FIG. 12B is a cross section view (cross section view along the line B-B′ in FIG. 11) of the solid-state image sensor according to Embodiment 2.

FIG. 13A is a top view showing a structure of the solid-state image sensor in which wiring that provides a driving pulse to a transfer electrode does not have a shunt wiring structure.

FIG. 13B is a diagram showing a waveform of a driving pulse in each of parts in the solid-state image sensor.

FIG. 14A is a top view showing a structure of a solid-state image sensor in which wiring that provides a driving pulse to a transfer electrode has a shunt wiring structure.

FIG. 14B is a diagram showing a waveform of a driving pulse in each of parts in the solid-state image sensor.

FIG. 15 is a cross section view of a solid-state image sensor for describing a mechanism in which transfer efficiency of a vertical CCD is deteriorated.

FIG. 16 is a diagram showing a waveform of a reading voltage.

FIG. 17 is a cross section view of a solid-state image sensor in which wiring that provides a driving pulse to a transfer electrode has a shunt wiring structure.

FIG. 18 is a diagram showing a schematic structure of the solid-state imaging device according to a modification of Embodiments 1 and 2.

FIG. 19 is a diagram showing a detailed structure of the solid-state image sensor according to the modification.

FIG. 20 is a timing diagram showing a method for transferring a signal charge in a vertical CCD according to the modification.

FIG. 21 is a charge transfer conceptual diagram showing the method for transferring the signal charge in the vertical CCD according to the modification.

FIG. 22 is a potential distribution variation diagram showing the method for transferring the signal charge in the vertical CCD according to the modification.

FIG. 23A is a timing diagram showing signal charge mixture in the vertical CCD according to the modification.

FIG. 23B is a charge mixture transfer conceptual diagram showing the signal charge mixture in the vertical CCD according to the modification.

FIG. 23C is a potential distribution variation diagram showing the signal charge mixture in the vertical CCD according to the modification.

FIG. 23D is a potential distribution variation diagram showing signal charge mixture in the vertical CCD according to the modification.

FIG. 24A is a timing diagram showing the method for transferring the signal charge in the vertical CCD according to the modification.

FIG. 24B is a charge transfer conceptual diagram showing the method for transferring the signal charge in the vertical CCD according to the modification.

FIG. 24C is a potential distribution variation diagram showing the method for transferring the signal charge in the vertical CCD according to the modification.

FIG. 25A is a timing diagram regarding a reading control signal and a VOF barrier control signal according to Embodiment 3 of the present invention.

FIG. 25B is a timing diagram regarding the reading control signal and the VOF barrier control signal according to Embodiment 3.

FIG. 25C is a timing diagram regarding the reading control signal and the VOF barrier control signal according to Embodiment 3.

FIG. 25D is a timing diagram regarding the reading control signal and the VOF barrier control signal according to Embodiment 3.

FIG. 25E is a timing diagram regarding the reading control signal and the VOF barrier control signal according to Embodiment 3.

FIG. 25F is a timing diagram regarding the reading control signal and the VOF barrier control signal according to Embodiment 3.

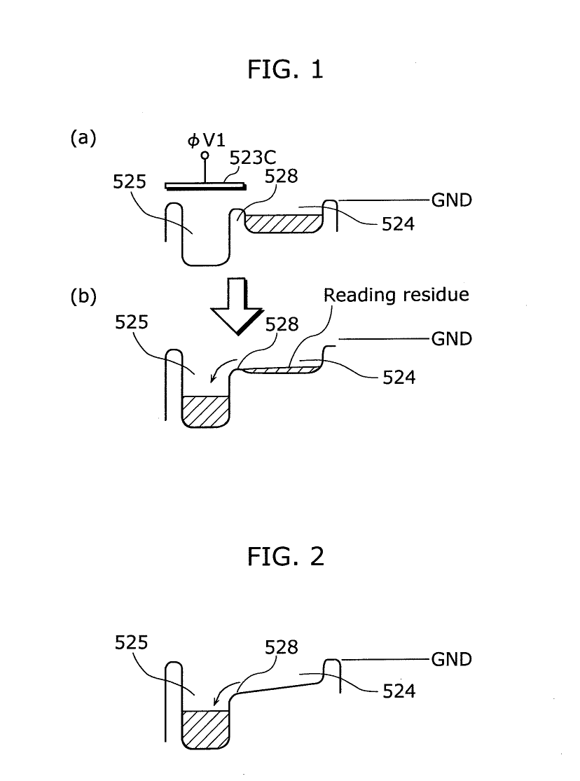

### NUMERICAL REFERENCES

100 Solid-state image sensor

110 Clock driver (VDr)

120 Pre-processing unit (CDS/ADC)

130 Digital signal processing unit (DSP)

140 Timing generator (TG)

210, 460, 524 Photodiode

220, 470, 525 Vertical CCD

230 Horizontal CCD

240 Output amplifier

300a, 300b, 300c, 440,

473a, 473b, 473c Conductive light-shielding film

320, 450, 474 Contact

330, 473 Light-shielding film

400 Peripheral wiring

410 φV Electrode

430 Imaging area

471, 471a, 471b, 471c, 523C Transfer electrode

472 Gate insulator film

528 Channel stop

### BEST MODE FOR CARRYING OUT THE INVENTION

The following describes a method for driving a solid-state imaging device according to embodiments of the present invention with reference to the drawings.

### Embodiment 1

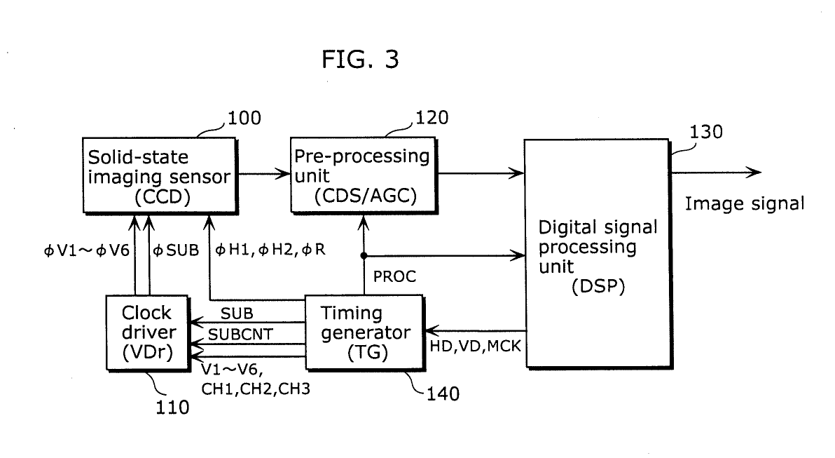

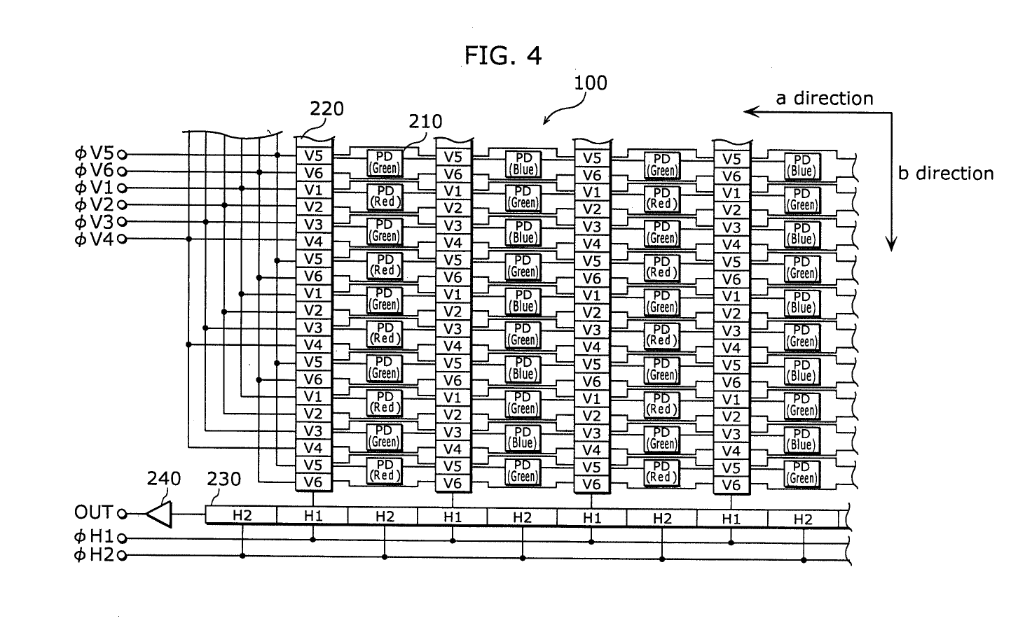

FIG. 3 is a diagram showing a schematic structure of a solid-state imaging device according to Embodiment 1.

As shown in FIG. 3, the solid-state imaging device includes: a CCD solid-state image sensor 100 which photoelectrically converts incident light and transfers a signal charge generated by the photoelectric conversion; a clock driver (VDr) 110; a pre-processing unit (CDS/ADC) 120 which performs CDS (correlated double sampling) or ADC (analog-digital conversion); a digital signal processing unit (DSP) 130 which performs, for instance, pixel interpolation or brightness and color difference processing, and outputs a video signal; and a timing generator (TG) 140.

The VDr 110 generates driving pulses φV1 to φV6 based on logic signals V1 to V6, and CH1, 2, and 3 that are outputted by the TG 140, provides the driving pulses φV1 to φV6 to the solid-state image sensor 100, and controls charge transfer of a vertical CCD. The driving pulses φV1 to φV6 are pulses having three electric potentials: a high level electric potential V_{H}; a middle level electric potential V_{M} that is lower than the electric potential V_{H}; and a low level electric potential V_{L} that is lower than the electric potential V_{M}. For example, the driving pulses φV1 to φV6 are pulses having three electric potentials: 12V as the electric potential V_{H}; 0V as the electric potential V_{M}; and −6V as the electric potential V_{L}. It is to be noted that the VDr 110 is an example of a transfer control unit of the present invention.

The TG 140 receives an input of each of pulses of a horizontal synchronization signal HD, a vertical synchronization signal VD, and a clock signal MCK from the DSP 130, generates driving pulses φH1, φH2, and φR to be used for driving the solid-state image sensor 100, and the logic signals V1 to V6, and CH1, 2, and 3, and outputs a signal processing pulse PROC to the pre-processing unit 120 and the DSP 130.

FIG. 4 is a diagram showing a detailed structure of the solid-state image sensor 100 according to the present embodiment.

In the solid-state image sensor 100, photodiodes 210, vertical CCDs (vertical transfer units) 220, a horizontal CCD (horizontal transfer unit) 230, and an output amplifier 240 are formed on a silicon substrate.

The photodiodes 210 are arranged in columns and rows (two-dimension), and accumulate signal charges generated by photoelectric conversion. Each of color filters respectively having one of three colors of red (R), green (G), and blue (B) is placed on a corresponding one of the photodiodes 210.

Each of the vertical CCDs 220 is a six-phase driving CCD which is provided for a corresponding one of the columns of the photodiodes 210 and includes transfer electrodes V1 to V6. The driving pulses φV1 to φV6 are applied to the transfer electrodes V1 to V6, respectively. The vertical CCD 220 transfers, in a column direction (b direction in FIG. 4), signal charges read from the photodiodes 210 according to the application of the driving pulses φV1 to φV6.

The horizontal CCD 230 is a two-phase driving CCD which includes transfer electrodes H1 and H2. The driving pulses φH1 and φH2 are applied to the transfer electrodes H1 and H2, respectively. The horizontal CCD 230 transfers, in a row direction (a direction in FIG. 4), the signal charges transferred by the vertical CCDs 220 according to the application of the driving pulses φH1 and φH2.

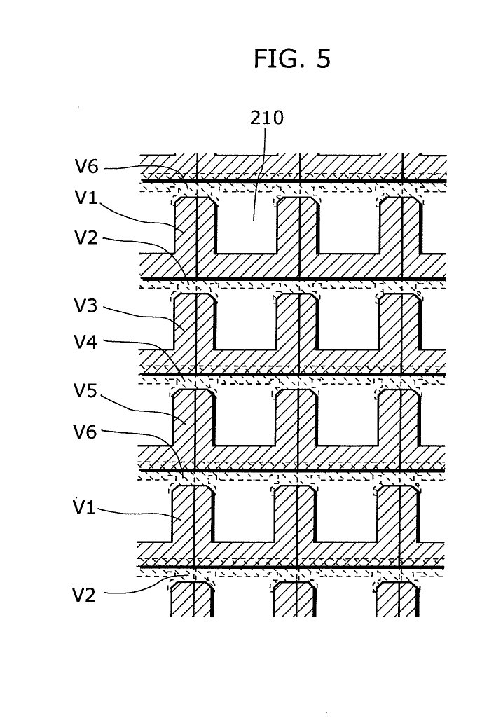

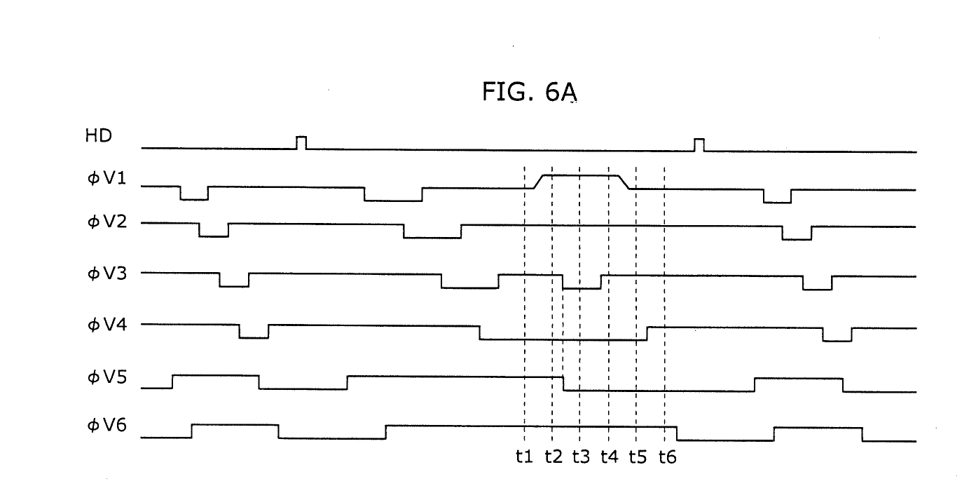

FIG. 5 is a top view showing an electrode structure of the vertical CCD 220. FIG. 5 shows that one of two adjacent transfer electrodes of the vertical CCD 220 has a larger area than the other adjacent transfer electrode. More specifically, transfer electrodes V1, V3, and V5 has a larger area than transfer electrodes V2, V4, and V6. Accordingly, an area of a transfer electrode which is provided on a reading path of a signal charge of the photodiode 210 and to which a reading voltage for reading the signal charge of the photodiode 210, that is, the electric potential V_{H}, is applied becomes larger. As a result, even when pixels are miniaturized, it is possible to ensure a reading channel width necessary for reading a signal charge.

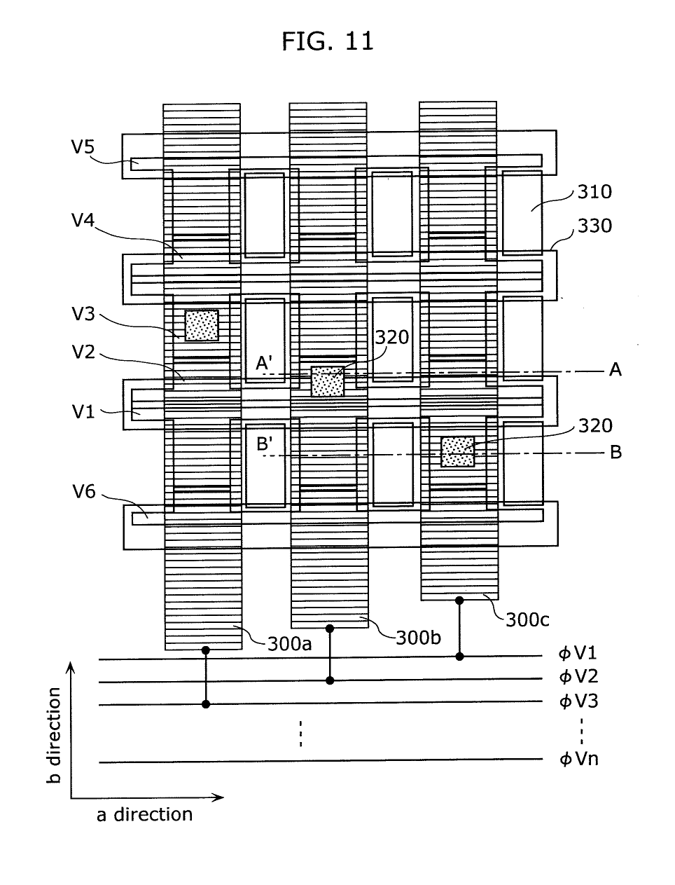

It is to be noted that although the two adjacent transfer electrodes of the vertical CCD 220 are formed with a double-layered structure in which parts of the transfer electrodes overlap with each other and has the double-layered structure as shown in FIG. 5, the solid-state imaging device according to the present embodiment of the present invention may have a single-layered structure in which the two adjacent transfer electrodes of the vertical CCD 220 do not overlap with each other and the two transfer electrodes are in contact with each other as shown in FIG. 11 to be described later. In the case of the single-layered structure, it is possible to reduce coupling capacitance between transfer electrodes.

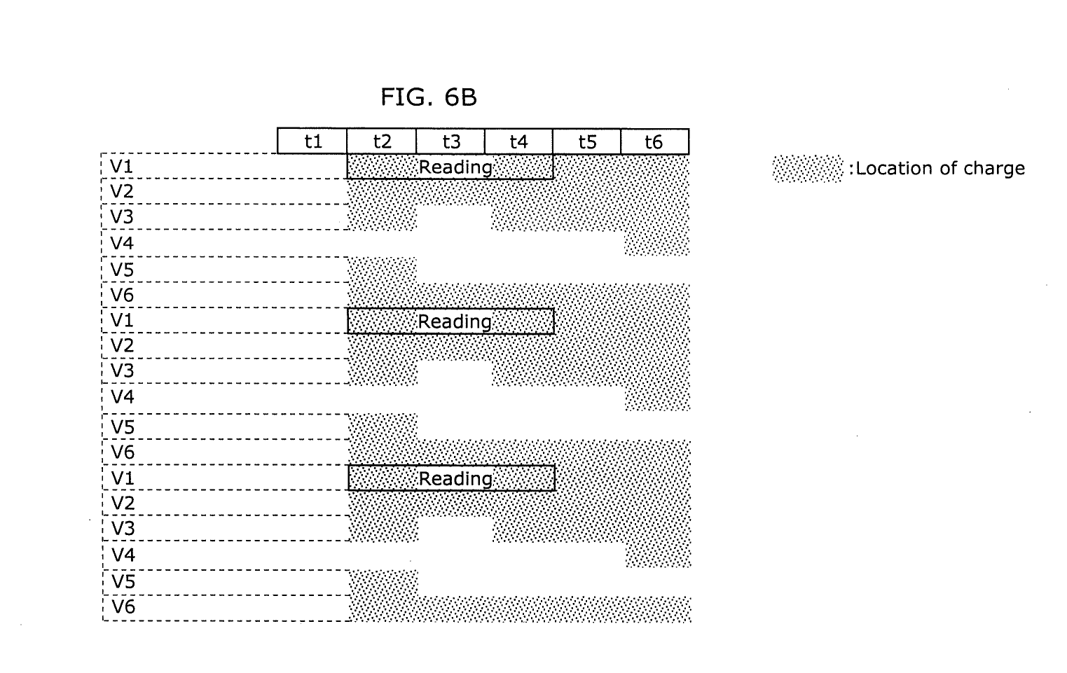

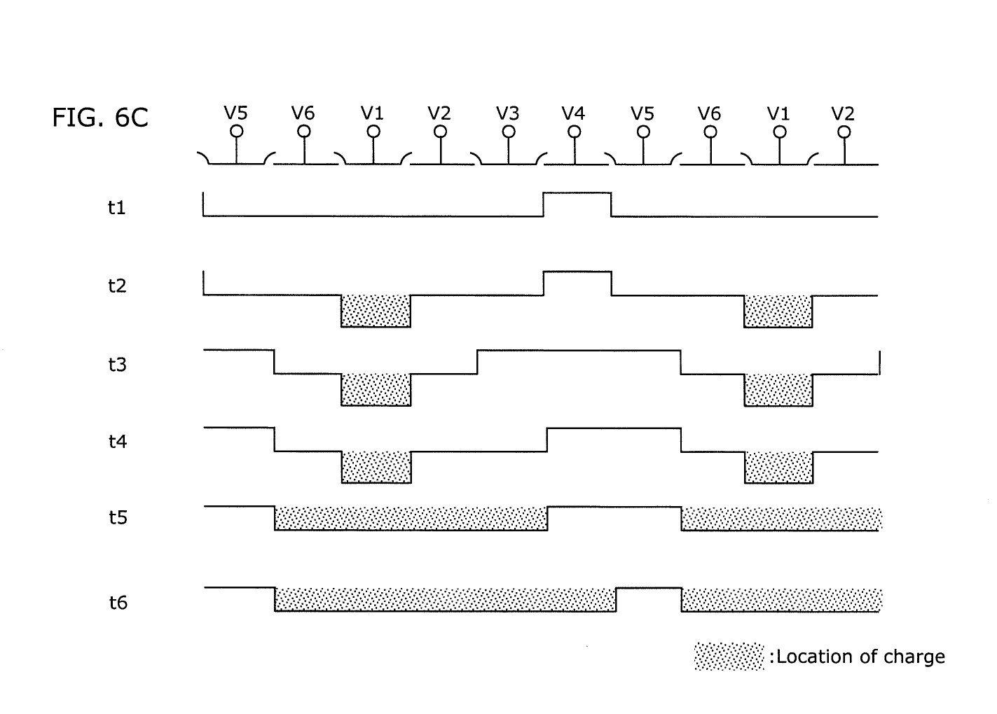

FIGS. 6A to 6C each are a diagram showing a method for transferring a signal charge in the vertical CCD 220 having the above structure. FIG. 6A is a timing diagram showing the method for transferring, FIG. 6B is a charge transfer conceptual diagram showing the method for transferring, and FIG. 6C is a potential distribution variation diagram showing the method for transferring. It is to be noted that the method for transferring is an example of the method for driving the solid-state imaging device of the present invention.

At a time t1, the driving pulse φV4 is at a low level, and the electric potential V_{L} is applied to the transfer electrode V4. Consequently, a potential well for accumulating signal charges is formed below the transfer electrodes V1 to V3 and V5 to V6.

At a time t2, the driving pulse φV1 is at a high level, and the electric potential V_{H} is applied to the transfer electrode V1. As a result, a signal charge of the photodiode 210 provided for the transfer electrode V1 is read into below the transfer electrode V1. When the electric potential V_{H} is applied to the transfer electrode V1, the driving pulses φV6 and φV2 are at a middle level and the electric potential V_{M} is applied to both the transfer electrodes V6 and V2 that are adjacent to the transfer electrode V1. Thus, since a difference in electric potentials between the adjacent transfer electrodes, that is, between the transfer electrode V1 and the transfer electrodes V6 and V2 becomes smaller, the high electric field is not produced on the substrate unlike the technique disclosed by Patent Reference 1, and it is possible to suppress the aged deterioration of the vertical CCD.

At a time t3, the driving pulses φV3 and φV5 each are concurrently changed into an electric potential having a reverse polarity with respect to the driving pulse φV1 so as to be at a low level, and electric potentials of the transfer electrodes V3 and V5 each are concurrently changed into the electric potential V_{L} having a reverse polarity with respect to the electric potential V_{H}. This can suppress an influence on variation in electric potential below the transfer electrode V1 that contributes to reading a signal charge, and a potential shape below the transfer electrode V1 is changed into a large slope gradually sloping downward from the photodiode 210 to the vertical CCD 220. Consequently, a reading residue when reading the signal charge of the photodiode 210 to the vertical CCD 220 can be prevented from occurring.

At a time t4, the driving pulse φV3 is at a middle level, and the electric potential V_{M} is applied to the transfer electrode V3. This further changes the potential shape below the transfer electrode V1 that contributes to reading the signal charge. As a result, the reading residue when reading the signal charge of the photodiode 210 to the vertical CCD 220 is highly likely to be prevented from occurring.

At a time t5, the driving pulse φV1 is at a middle level, and the electric potential V_{M} is applied to the transfer electrode V1. Consequently, the read signal charge is transferred to the potential well below the transfer electrodes V1 to V3 and V6.

At a time t6, the driving pulse φV4 is at a middle level, and the electric potential V_{M} is applied to the transfer electrode V4. As a result, the read signal charge is transferred to the potential well below the transfer electrodes V1 to V4 and V6.

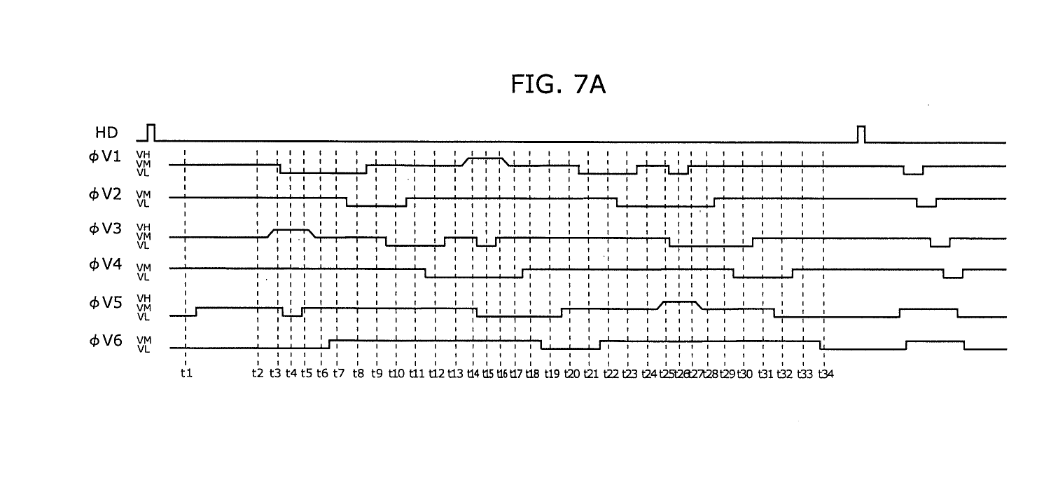

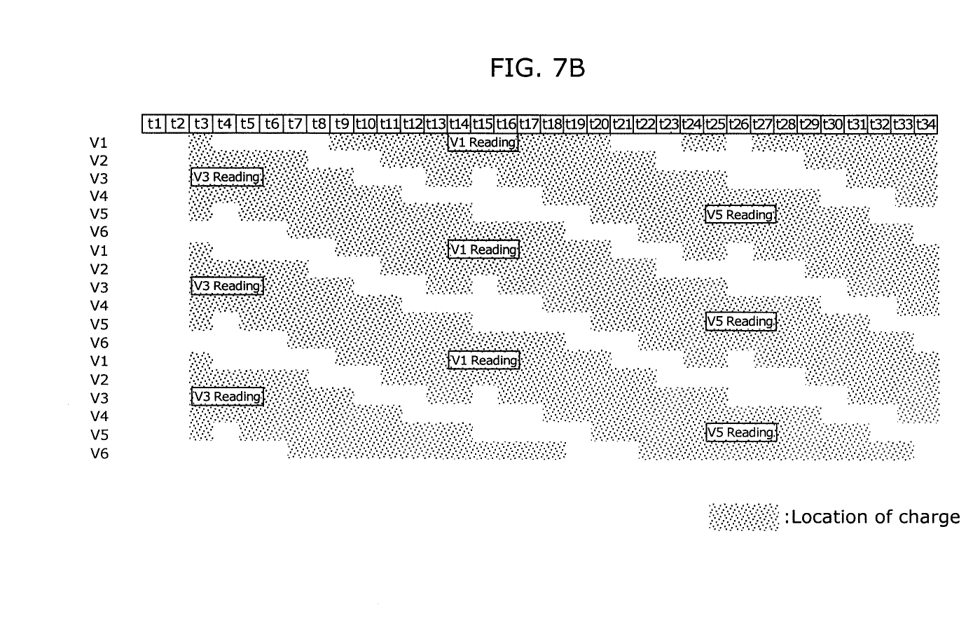

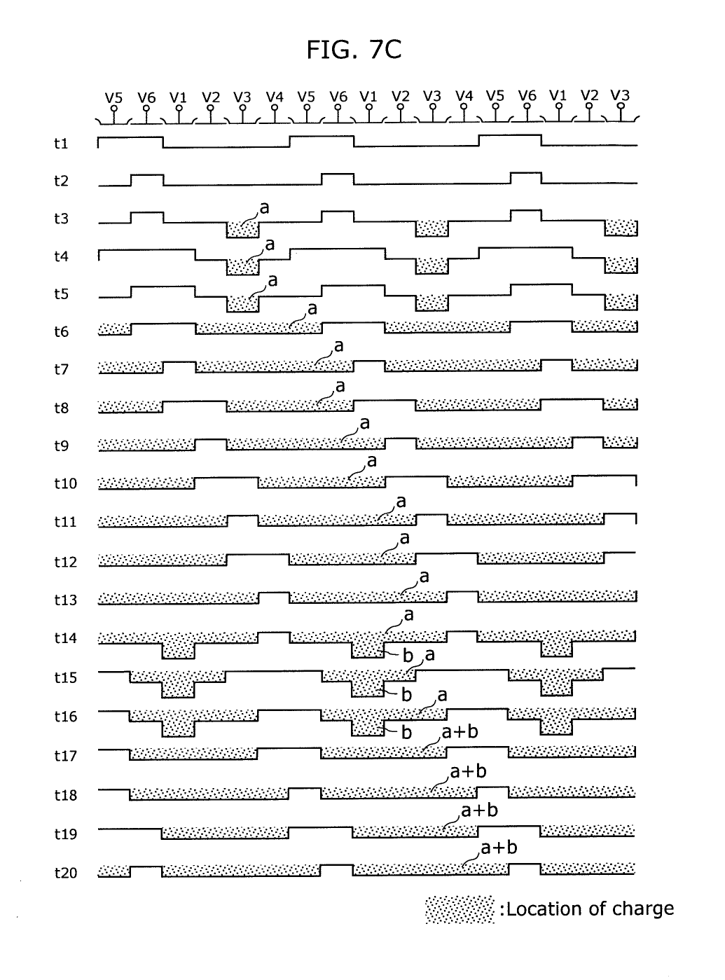

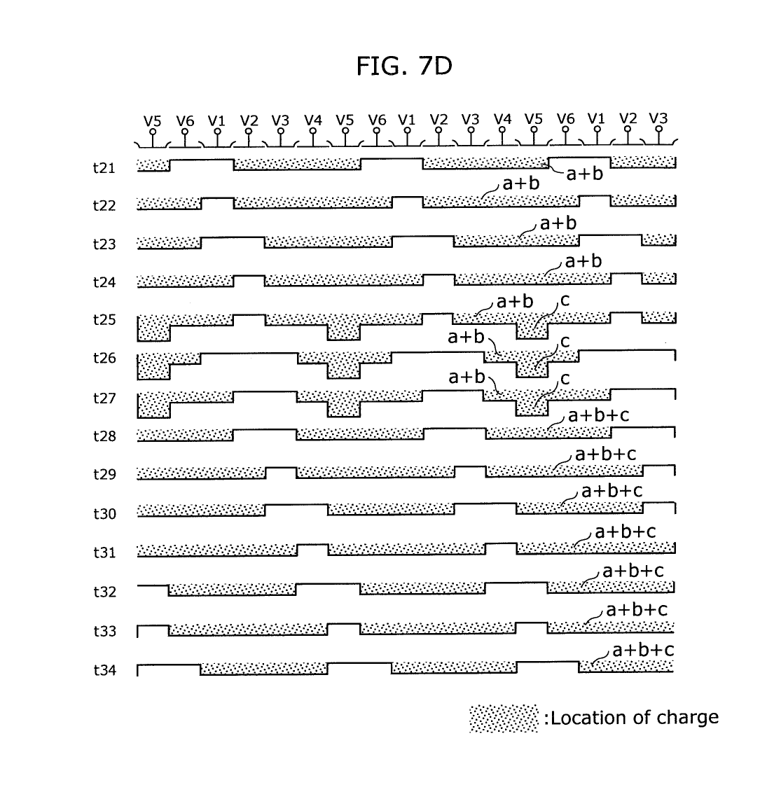

FIGS. 7A to 7D each are a diagram showing signal charge mixture (pixel mixture) in the vertical CCD 220 having the above structure. FIG. 7A is a timing diagram showing the signal charge mixture, FIG. 7B is a charge mixture transfer conceptual diagram showing the signal charge mixture; and FIGS. 7C and 7D each are a potential distribution variation diagram showing the signal charge mixture.

At a time t1, the driving pulses φV5 and φV6 are at a low level, and the electric potential V_{L} is applied to the transfer electrodes V5 and V6. Consequently, a potential well for accumulating signal charges is formed below the transfer electrodes V1 to V4.

At a time t2, the driving pulse φV5 is at a middle level, and the electric potential V_{M} is applied to the transfer electrode V5. As a result, a potential well for accumulating signal charges is formed below the transfer electrodes V1 to V5.

At a time t3, the driving pulse φV3 is at a high level, and the electric potential V_{H} is applied to the transfer electrode V3. Consequently, a signal charge (a in FIG. 7C) of the photodiode 210 provided for the transfer electrode V3 is read into below the transfer electrode V3. While the electric potential V_{H} is being applied to the transfer electrode V3, it is possible to suppress the aged deterioration of the vertical CCD 220 because the electric potential V_{M} is applied to both the transfer electrodes V2 and V4 that are adjacent to the transfer electrode V3 and a difference in electric potentials between the adjacent transfer electrodes becomes smaller.

At a time t4, the driving pulses φV1 and φV5 each are concurrently changed into an electric potential having a reverse polarity with respect to the driving pulse φV3 so as to be at a low level, and electric potentials of the transfer electrodes V1 and V5 each are concurrently changed into the electric potential V_{L} having a reverse polarity with respect to the electric potential V_{H}. Since this can suppress an influence on variation in electric potential below the transfer electrode V3 that contributes to reading a signal charge and further changes a potential shape below the transfer electrode V3 into a large slope gradually sloping downward from the photodiode 210 to the vertical CCD 220, a reading residue is prevented from occurring.

At a time t5, the driving pulse φV5 is at a middle level, and the electric potential V_{M} is applied to the transfer electrode V5. Since this further changes the potential shape below the transfer electrode V3 that contributes to reading a signal charge, the reading residue is highly likely to be prevented from occurring.

At a time t6, the driving pulse φV3 is at a middle level, and the electric potential V_{M} is applied to the transfer electrode V3. As a result, the read signal charge is transferred to the potential well below the transfer electrodes V2 to V5.

At times t7 to t13, the read signal charges are transferred to the potential well below the transfer electrodes V1 to V3, V5, and V6 by changing the electric potentials of the driving pulses φV1 to φV4.

At a time t14, the driving pulse φV1 is at a high level, and the electric potential V_{H} is applied to the transfer electrode V1. Consequently, a signal charge (b in FIG. 7C) of the photodiode 210 provided for the transfer electrode V1 is read into below the transfer electrode V1, and the read signal charge is mixed with the already-read signal charge (a in FIG. 7C). While the electric potential V_{H} is being applied to the transfer electrode V1, it is possible to suppress the aged deterioration of the vertical CCD 220 because the electric potential V_{M} is applied to both the transfer electrodes V6 and V2 that are adjacent to the transfer electrode V1 and a difference in electric potentials between the adjacent transfer electrodes becomes smaller.

At times t15 to t24, the same operations performed between t4 and t13 are performed, and mixed signal charges (a+b in FIG. 7C) are transferred to the potential well below the transfer electrodes V3 to V6 and V1.

At a time t25, the driving pulse φV5 is at a high level, and the electric potential V_{H} is applied to the transfer electrode V5. As a result, a signal charge (c in FIG. 7D) of the photodiode 210 provided for the transfer electrode V5 is read into below the transfer electrode V5, and the read signal charge is mixed with an already-mixed signal charge (a+b in FIG. 7D). While the electric potential V_{H} is being applied to the transfer electrode V5, it is possible to suppress the aged deterioration of the vertical CCD 220 because the electric potential V_{M} is applied to both the transfer electrodes V4 and V6 that are adjacent to the transfer electrode V5 and a difference in electric potentials between the adjacent transfer electrodes becomes smaller.

At times t26 to t34, mixed signal charges (a+b+c in FIG. 7D) are transferred to the horizontal CCD 230.

As described above, in the method for transferring the signal charge according to the present embodiment, when the signal charge of the photodiode 210 is read, not the electric potential V_{L} but the electric potential V_{M} is applied to a transfer electrode adjacent to another transfer electrode to which a reading voltage, that is, the electric potential V_{H} is applied. Therefore, since the method for transferring the signal charge according to the present embodiment can reduce the difference in electric potentials between the adjacent transfer electrodes more than the method disclosed by Patent Reference 1, it is possible to suppress the aged deterioration of the vertical CCD.

Furthermore, in the method for transferring the signal charge according to the present embodiment, when the signal charge of the photodiode 210 is read, electric potentials of two transfer electrodes that are not adjacent to a transfer electrode to which a reading voltage is applied are changed. Thus, the influence on the variation in electric potential below the transfer electrode to which the reading voltage is applied can be suppressed, and the potential shape below the transfer electrode is further changed into a large slope gradually sloping downward from the photodiode 210 to the vertical CCD 220.

Consequently, since the reading residue when reading the signal charge of the photodiode 210 to the vertical CCD 220 can be prevented from occurring, the reading voltage can be reduced. When the reading residue occurs, an image defect such as surface roughness of an image occurs because a variation in an amount of signal charge read for each of the photodiodes 210 occurs. Therefore, preventing the reading residue from occurring leads to prevention of the image defect.

Moreover, in the method for transferring the signal charge according to the present embodiment, when the signal charge of the photodiode 210 is read, an electric potential of a transfer electrode that is not adjacent to the transfer electrode to which the reading voltage is applied is changed twice. Thus, the potential shape below the transfer electrode to which the reading voltage is applied is further changed. As a result, since the reading residue when reading the signal charge of the photodiode 210 to the vertical CCD 220 is highly likely to be prevented from occurring, it is possible to significantly reduce the reading voltage. In addition, since the electric potential of the transfer electrode that is not adjacent to the transfer electrode to which the reading voltage is applied is changed and then the changed electric potential can be restored, it is possible to significantly reduce the reading voltage without sacrificing a transfer capability.

Furthermore, in the method for transferring the signal charge according to the present embodiment, the vertical CCD 220 is the six-phase driving CCD which includes the transfer electrodes V1 to V6. Thus, even when the pixels are miniaturized along with miniaturization of a solid-state imaging device and the transfer capability of the vertical CCD is reduced, a sufficient transfer capability can be ensured, and it is possible to achieve a balance between the miniaturization of the solid-state imaging device and enhancement of image characteristics such as sensitivity characteristics, smear characteristics, and saturation characteristics.

It is to be noted that although the electric potentials of the two transfer electrodes that are not adjacent to the transfer electrode to which the reading voltage is applied are changed in the method for transferring the signal charge according to the present embodiment, only an electric potential of one transfer electrode may be changed.

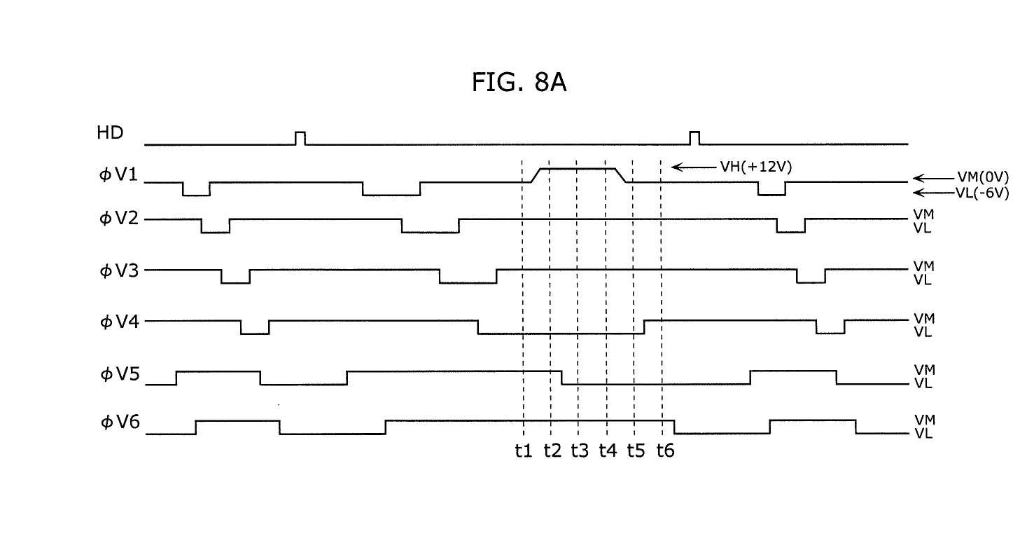

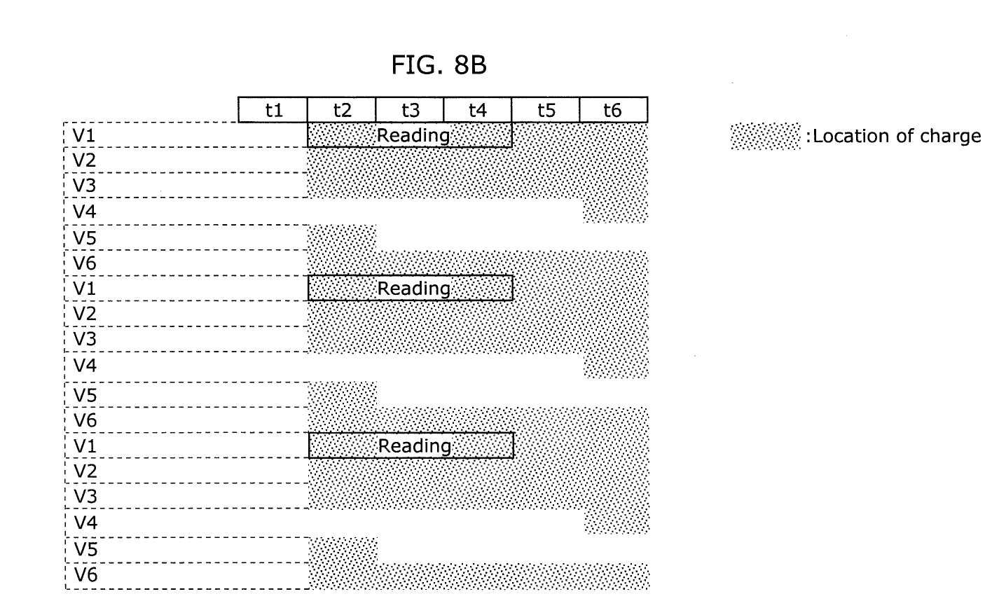

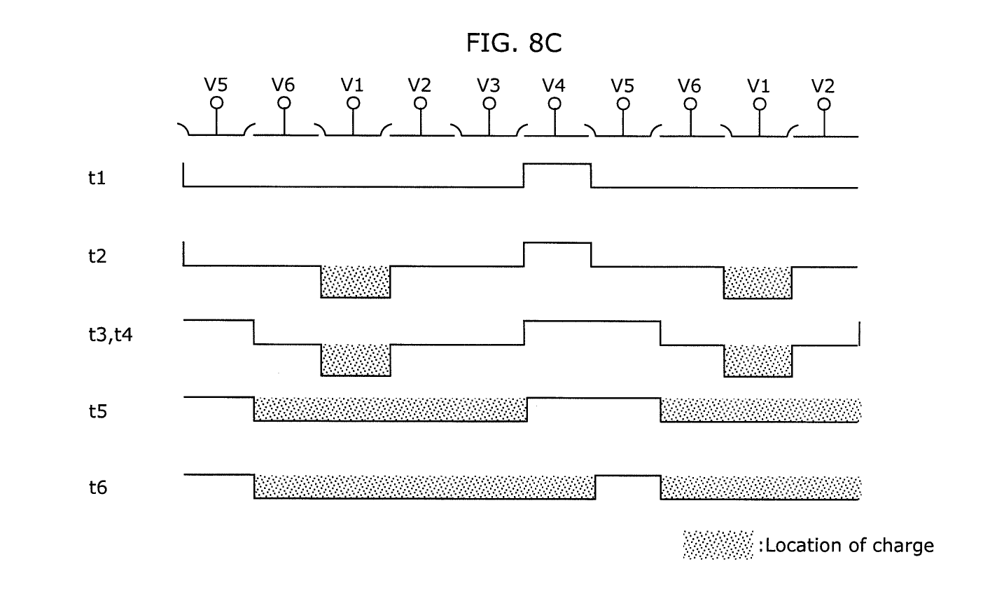

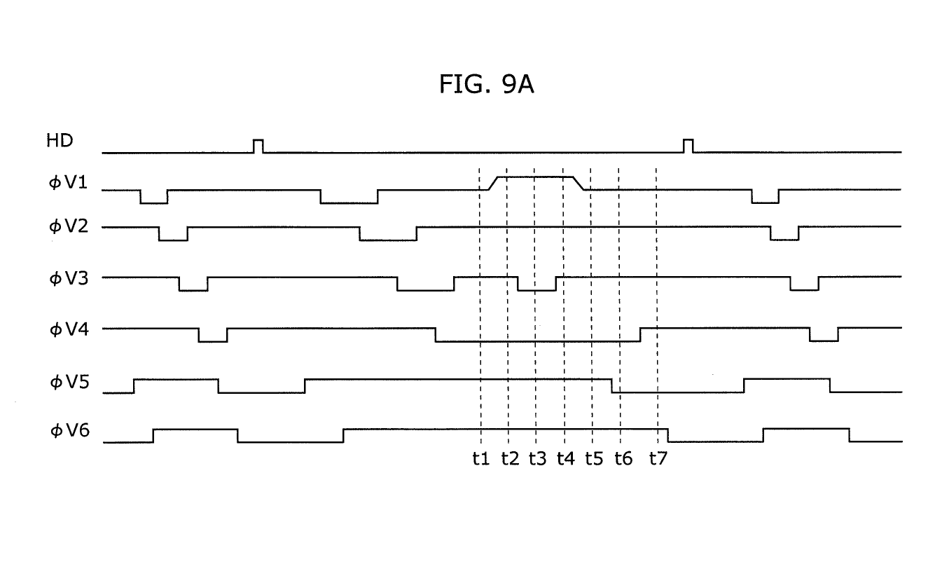

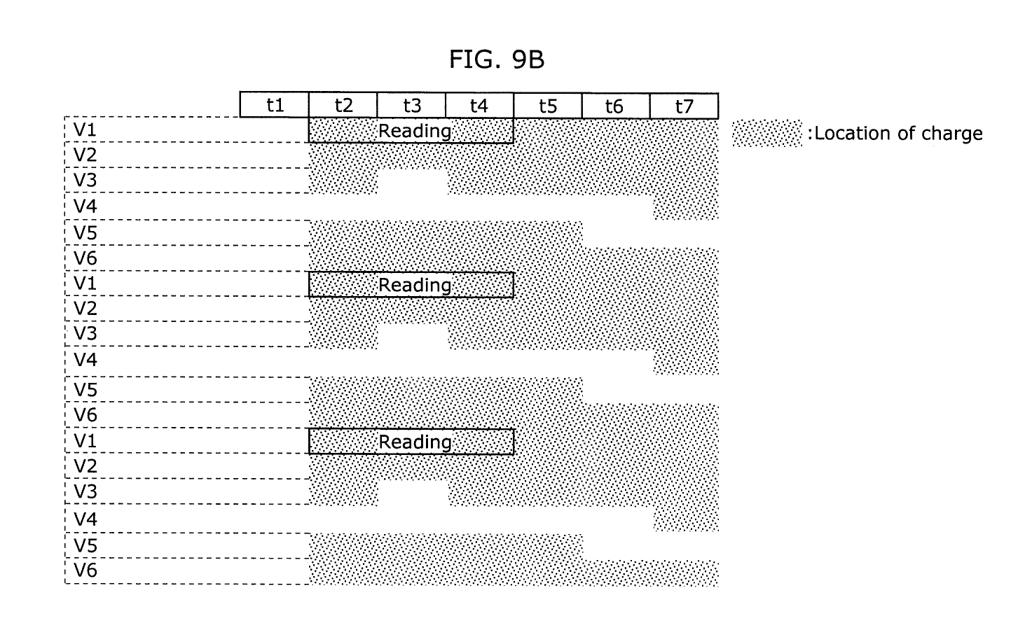

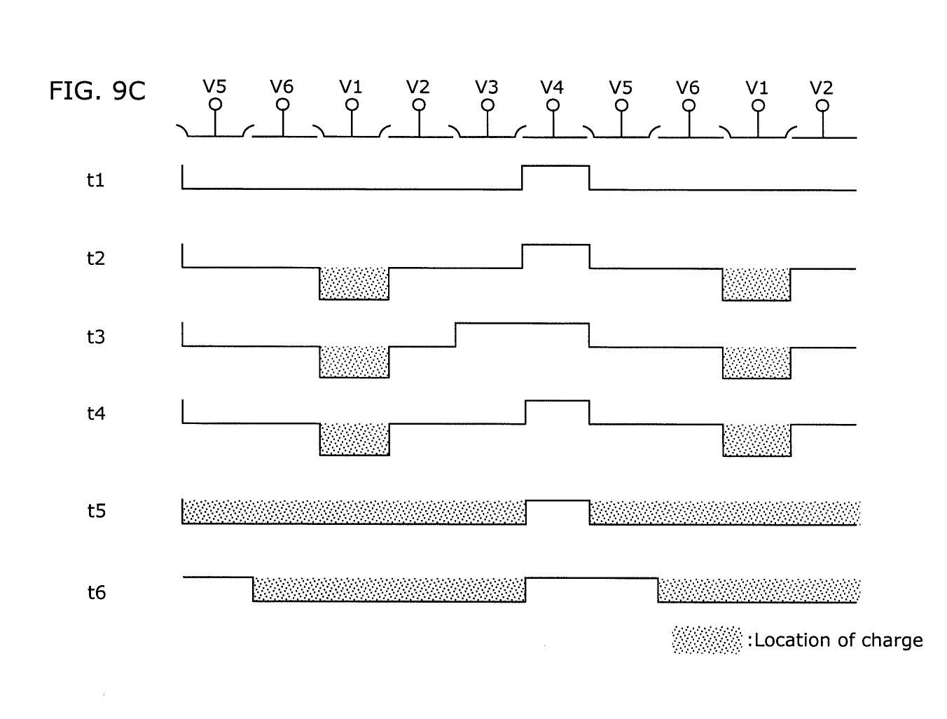

FIGS. 8A to 8C and FIGS. 9A to 9C each are a diagram showing the method for transferring the signal charge in the above case. FIGS. 8A and 9A each are a timing diagram showing the method for transferring, FIGS. 8B and 9B each are a charge transfer conceptual diagram showing the method for transferring, and FIGS. 8C and 9C each are a potential distribution variation diagram showing the method for transferring.

The method for transferring the signal charge shown in FIGS. 8A to 8C differs from the method for transferring the signal charge shown in FIG. 6 in that at a time t3, only the driving pulse φV5 is changed to be at a low level, and only the electric potential of the transfer electrode V5 is changed into the electric potential V_{L}. The method for transferring the signal charge shown in FIGS. 9A to 9C differs from the method for transferring the signal charge shown in FIG. 6 in that at the time t3, only the driving pulse φV3 is changed to be at a low level, and only the electric potential of the transfer electrode V3 is changed into the electric potential V_{L}. In any of the above cases, since a potential well becomes larger in comparison with the method for transferring the signal charge according to the present embodiment, it is possible to increase the charge transfer capability.

Moreover, although the electric potential of the two transfer electrodes that are not adjacent to the transfer electrode to which the reading voltage is applied are concurrently changed in the method for transferring the signal charge according to the present embodiment, an electric potential of one of the two transfer electrodes may be changed and then an electric potential of the other transfer electrode may be changed.

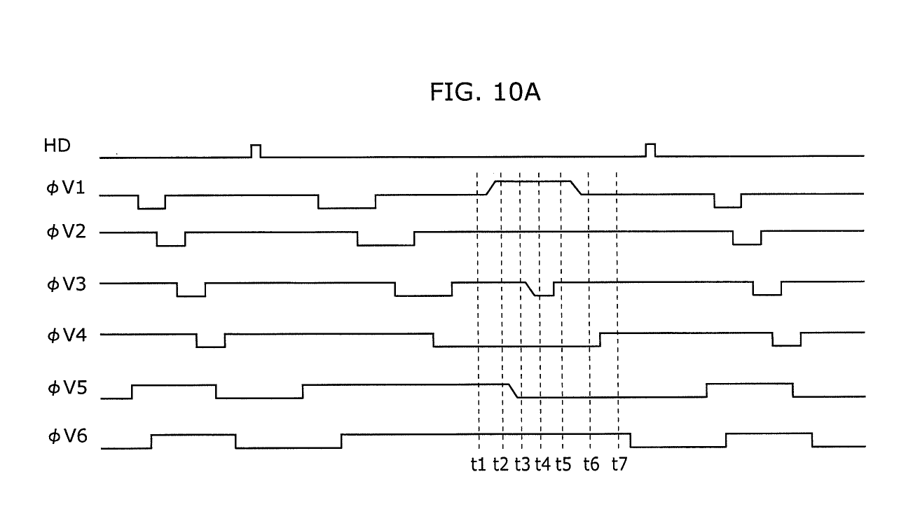

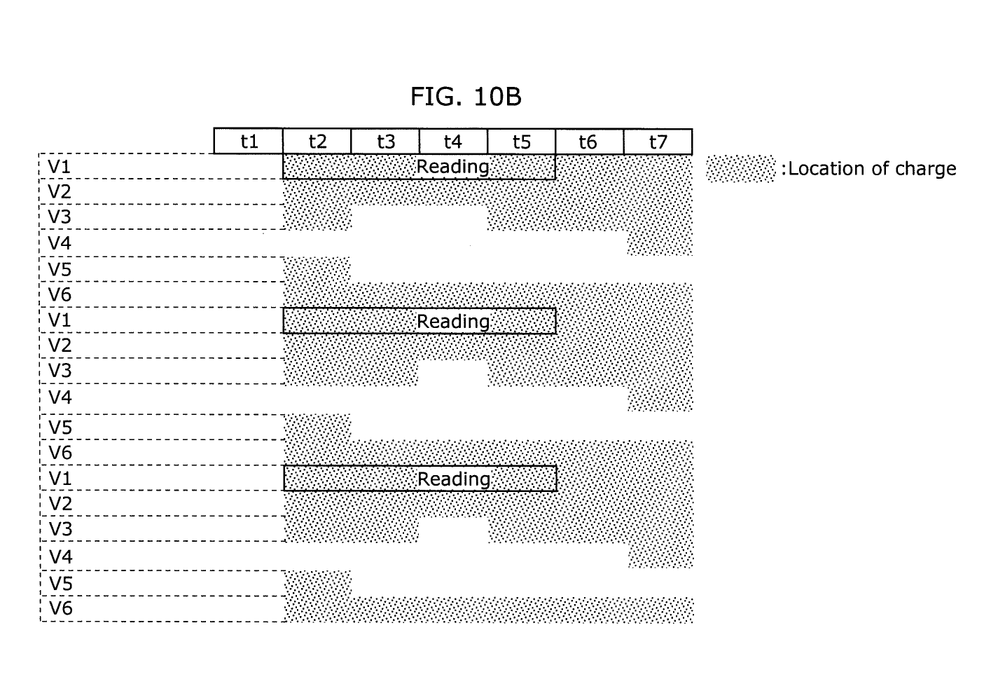

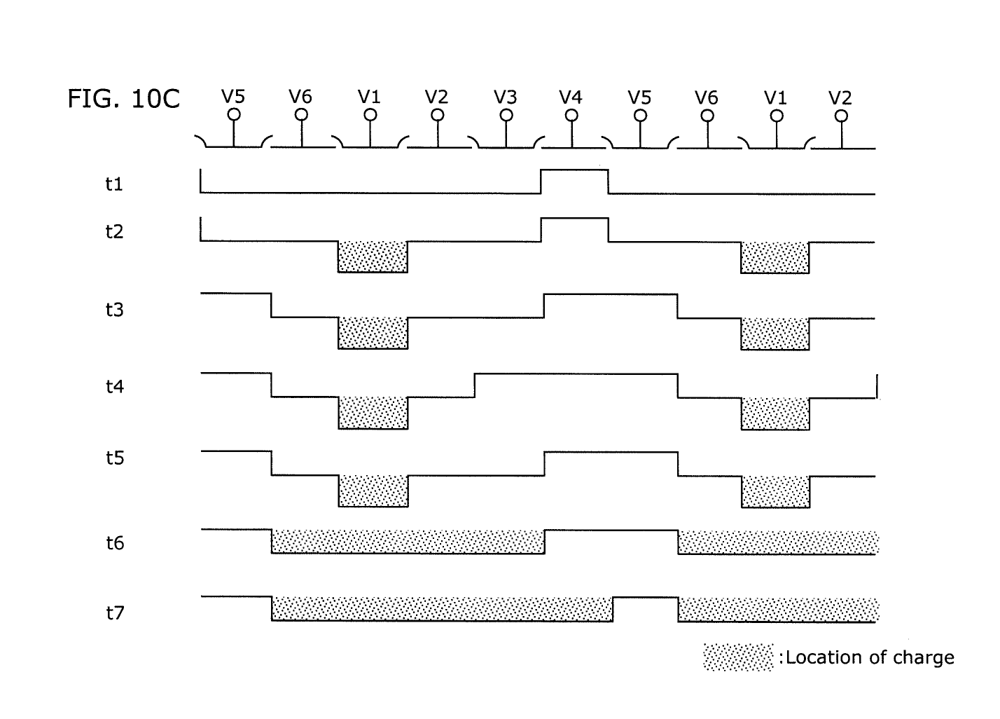

FIGS. 10A to 10C each are a diagram showing the method for transferring the signal charge in the above case. FIG. 10A is a timing diagram showing the method for transferring, FIG. 10B is a charge transfer conceptual diagram showing the method for transferring, and FIG. 10C is a potential distribution variation diagram showing the method for transferring.

The above method for transferring the signal charge differs from the method for transferring the signal charge shown in FIG. 6 in that at a time t3, the driving pulse φV5 is changed to be at a low level and the electric potential of the transfer electrode V5 is changed into the electric potential V_{L}, and then at a time t4, the driving pulse φV3 is changed to be at a low level and the electric potential of the transfer electrode V3 is changed to the electric potential V_{L}.

In addition, although the electric potential of the transfer electrode that is not adjacent to the transfer electrode to which the reading voltage is applied is changed twice in the method for transferring the signal charge according to the present embodiment, the electric potential of one transfer electrode may be changed once or more than three times.

### Embodiment 2

A solid-state imaging device according to Embodiment 2 differs from the solid-state imaging device according to Embodiment 1 in that wiring which provides driving pulses to transfer electrodes V1 to V6 has a shunt wiring structure. Stated differently, in the solid-state imaging device according to the present embodiment, a light-shielding film which is provided above a vertical CCD and prevents light from being incident on a vertical charge transfer path of the vertical CCD (VCCD) is a conductive light-shielding film, and functions as wiring that provides driving pulses to transfer electrodes of the vertical CCD.

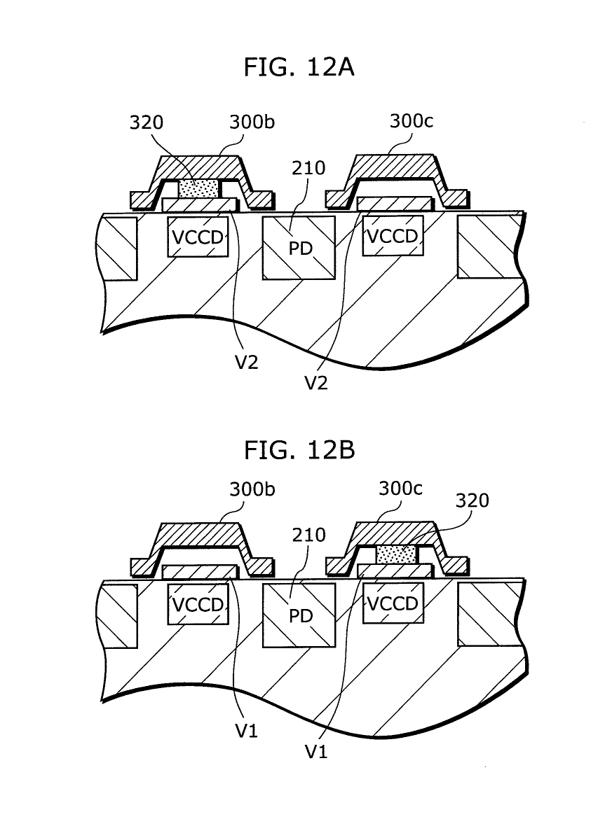

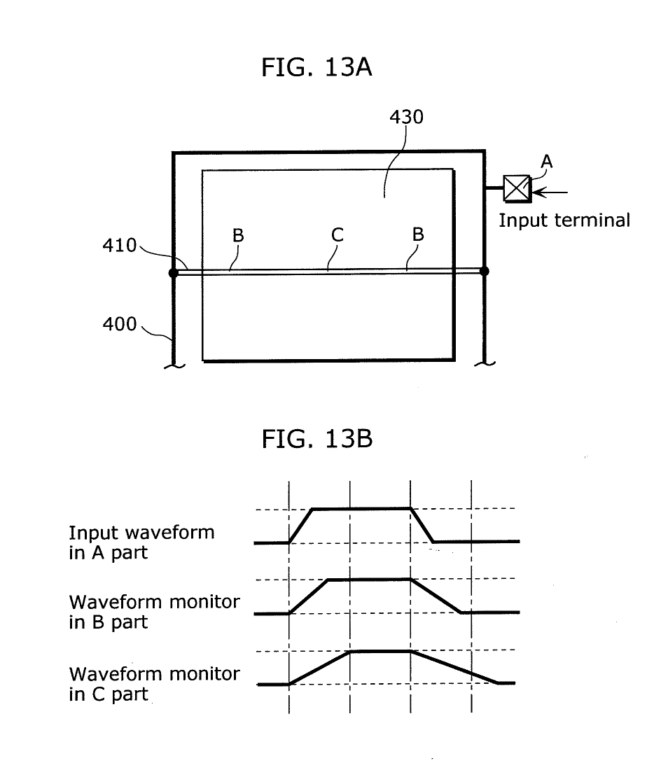

FIG. 11 is a top view showing a structure of the solid-state imaging device (solid-state image sensor) according to the present embodiment. FIG. 12A is a cross section view (cross section view along the line A-A′ in FIG. 11) of the solid-state image sensor. FIG. 12B is a cross section view (cross section view along the line B-B′ in FIG. 11) of the solid-state image sensor.

The solid-state image sensor includes: conductive light-shielding films 300a, 300b, and 300c that are provided above the vertical CCD, that is, the transfer electrodes V1 to V6 and that extend in a column direction (b direction in FIG. 11); and a light-shielding film 330 that extends in a row direction (a direction in FIG. 11). Each of the conductive light-shielding films 300a, 300b, and 300c is electrically isolated in a column direction. The conductive light-shielding film 300a is electrically connected to the transfer electrode V3 via a contact 320, and provides the driving pulse φV3 to the transfer electrode V3. The conductive light-shielding film 300b is electrically connected to the transfer electrode V2 via the contact 320, and provides the driving pulse φV2 to the transfer electrode V2. The conductive light-shielding film 300c is electrically connected to the transfer electrode V1 via the contact 320, and provides the driving pulse φV1 to the transfer electrode V1.

As described above, in the solid-state imaging device according to the present embodiment, the signal charges are transferred in the vertical CCD with the same method for transferring the signal charge as Embodiment 1. Thus, it is possible to suppress the aged deterioration of the vertical CCD and reduce the reading voltage.

Moreover, in the solid-state imaging device according to the present embodiment, the wiring that provides the driving pulses to the transfer electrodes V1 to V6 of the solid-state image sensor has the shunt wiring structure. Thus, it is possible to transfer the signal charges at high speed. This will be described in detail later.

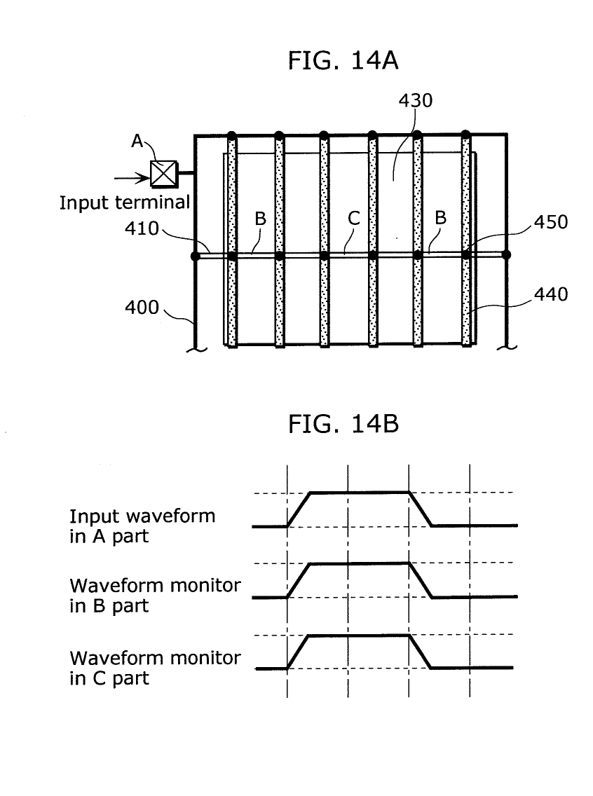

FIG. 13A is a top view showing a structure of a solid-state image sensor in which wiring that provides a driving pulse to a transfer electrode does not have a shunt wiring structure, and FIG. 13B is a diagram showing a waveform of a driving pulse in each of parts in the solid-state image sensor. FIG. 14A is a top view showing a structure of a solid-state image sensor in which wiring that provides a driving pulse to a transfer electrode has a shunt wiring structure, and FIG. 14B is a diagram showing a waveform of a driving pulse in each of parts in the solid-state image sensor.

In any of the solid-state image sensors, peripheral wiring 400 made of a metal material is connected to an input terminal, and a φV electrode 410 made of a polysilicon material is connected to the peripheral wiring 400. Since resistance components of the polysilicon material are high, a waveform of a driving pulse transmitted to the φV electrode 410 becomes dull. Since this becomes more remarkable as a wiring distance from the input terminal is longer, as shown in FIG. 13B, waveforms at the input terminal (A part in FIG. 13A), a peripheral part (B part in FIG. 13A) of an imaging region 430, and a central part (C part in FIG. 13A) differ in pattern from each other. As a result, a transfer speed of the vertical CCD is reduced, and a charge transfer capability differs between at the peripheral part and at the central part of the imaging region 430.

However, in the solid-state image sensor shown in FIG. 14A, a conductive light-shielding film 440 that is made of a metal material such as tungsten is connected to the peripheral wiring 400 and the φV electrode 410 via a contact 450. Since resistance components of the metal material are low, a waveform of a driving pulse transmitted to the conductive light-shielding film 440 hardly becomes dull. Thus, as shown in FIG. 14B, waveforms of driving pulses at an input terminal (A part in FIG. 14A), a peripheral part of the imaging region 430 (B part in FIG. 14A), and a central part (C part in FIG. 14A) become substantially identical to each other. As a result, the transfer speed of the vertical CCD is not reduced, and a difference in the charge transfer capability between at the peripheral part and at the central part of the imaging region 430 disappears.

On the other hand, since the solid-state image sensor in which the wiring that provides the driving pulse to the transfer electrode has the shunt wiring structure enables signal charge transfer at high speed but deteriorates transfer efficiency for signal charges of the vertical CCD, an image defect within an imaging region occurs which is not saliently seen in the solid-state image sensor in which the wiring that provides the driving pulse to the transfer electrode does not have the shunt wiring structure. The following describes the above in detail.

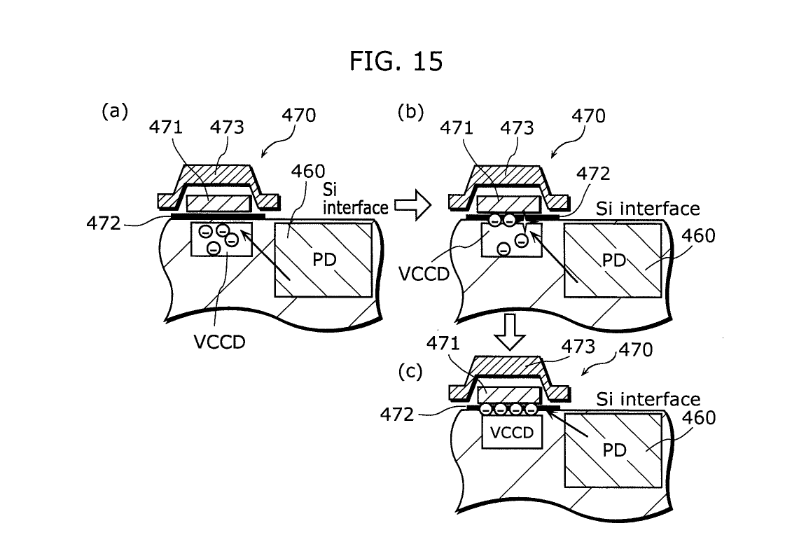

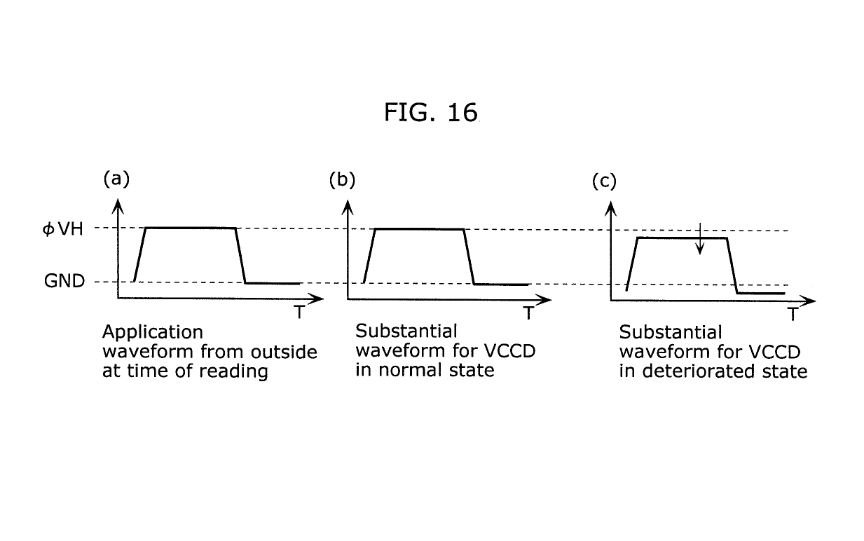

FIG. 15 is a cross section view of a solid-state image sensor for describing a mechanism in which transfer efficiency of a vertical CCD is deteriorated. FIG. 16 is a diagram showing a waveform of a reading voltage.

Although a signal charge accumulated by a photodiode 460 is read by applying a reading voltage to a transfer electrode 471 of a vertical CCD 470 below a light-shielding film 473 (FIG. 15(a)), when the reading is repeated by using the transfer electrode 471 for a long time, a portion of the signal charge penetrates a VCCD (FIG. 15(b)), the portion of the signal charge is trapped in a gate insulator film 472, and the vertical CCD deteriorates (FIG. 15(c)). Thus, although a reading voltage having a waveform (FIG. 16(b)) substantially identical to a waveform (FIG. 16(a)) of the reading voltage is applied to the VCCD in the vertical CCD in normal state (undeteriorated state), since the gate insulator film 472 has a negative electric charge, a reading voltage having a waveform (FIG. 16 (c)) which is obtained by shifting, to a negative side, the waveform (FIG. 16(a)) of the reading voltage which is applied to the transfer electrode 471 is applied to the VCCD in the vertical CCD in deteriorated state. As a result, the transfer efficiency of the vertical CCD deteriorates.

Such a deterioration in the transfer efficiency of the vertical CCD leads to a notable image defect such as surface roughness of an image in the solid-state image sensor in which the wiring that provides the driving pulse to the transfer electrode has the shunt wiring structure. The reason is that, unlike the solid-state image sensor in which the wiring that provides the driving pulse to the transfer electrode does not have the shunt wiring structure, since a degree of deterioration differs in each part of the vertical CCD, an impact given by the deterioration of the vertical CCD according to a photodiode differs and the deterioration of the vertical CCD appears as the notable image defect such as the surface roughness of the image.

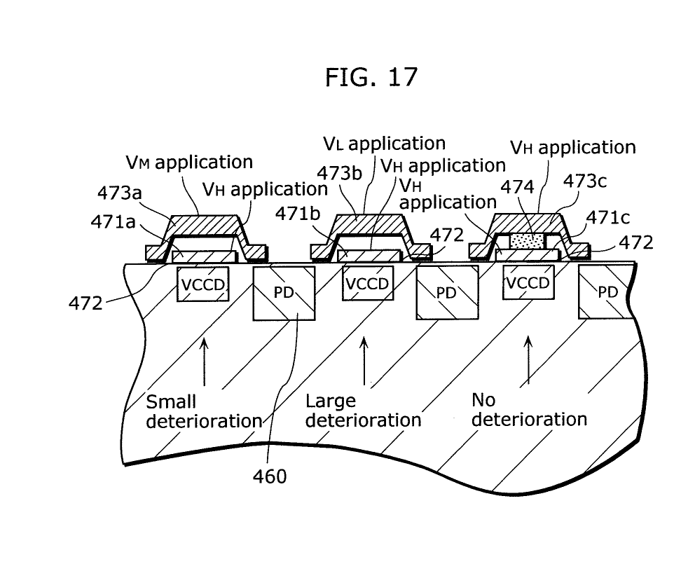

More specifically, as shown in the cross section view of the solid-state image sensor by FIG. 17, in a vertical CCD below a conductive light-shielding film 473c which provides a reading voltage (electric potential V_{H}), when the reading voltage (electric potential V_{H}) is applied to a transfer electrode 471c via a contact 474, a difference in electric potential is not generated between the transfer electrode 471c and the conductive light-shielding film 473c. Thus, trapping a portion of a signal charge in a gate insulator film 472 hardly occurs, and the deterioration of the vertical CCD is less likely to occur.

However, in a vertical CCD below a conductive light-shielding film 473a or 473b which provides a voltage (electric potential V_{M} or V_{L}) lower than the reading voltage, when the reading voltage (electric potential V_{H}) is applied to the transfer electrode 471a or 471b, a difference in electric potential is generated between the transfer electrode 471a and the conductive light-shielding film 473a or the transfer electrode 471b and the conductive light-shielding film 473b.

The difference in electric potential is especially large between the transfer electrode 471a and the conductive light-shielding film 473a. Thus, the deterioration of the vertical CCD is highly likely to occur in the vertical CCD below the conductive light-shielding film 473a or 473b. Consequently, the degree of deterioration differs in each part of the vertical CCD.

On the other hand, in the solid-state image sensor in which the wiring that provides the driving pulse to the transfer electrode does not have the shunt wiring structure, since the light-shielding film is either connected to GND or in unsteady state, the deterioration in the transfer efficiency of the vertical CDD itself does not occur easily, and even if the deterioration occurred, the deterioration would not lead to the notable image defect.

As stated above, since the solid-state imaging device according to the present embodiment makes it possible to suppress the aged deterioration of the vertical CCD, the solid-state imaging device according to the present embodiment is especially useful to a case where the deterioration of the vertical CCD occurs easily and the wiring that provides the driving pulse to the transfer electrode has the shunt wiring structure.

Although the method for driving the solid-state imaging device according to the present invention has been described based on the embodiments, the present invention is not limited to the embodiments. The present invention includes modifications conceived by a person with an ordinary skill in the art within the scope of the present invention.

For example, the vertical CCD is the six-phase driving CCD including the transfer electrodes V1 to V6 in the above embodiments. However, as long as the vertical CCD is a CCD to which the method for transferring the signal charge according to the above embodiments can be applied, that is, a CCD including transfer electrodes to which a five- or more phase driving pulse is applied, the vertical CCD is not limited to the above CCD, and may be, for instance, an eight-phase driving CCD.

### Modification of Embodiments 1 and 2

Although the above embodiments have described the solid-state image sensor in which the transfer electrodes (vertical transfer electrodes) of the vertical CCD have a six-phase structure, a solid-state image sensor in which vertical transfer electrodes have a twelve-phase structure can produce the same effect as the solid-state image sensor in which the transfer electrodes have the six-phase structure.

The following describes a solid-state imaging device in which the vertical transfer electrodes have the twelve-phase structure with reference to the drawings, the solid-state imaging device being the solid-state imaging device according to the embodiments of the present invention.

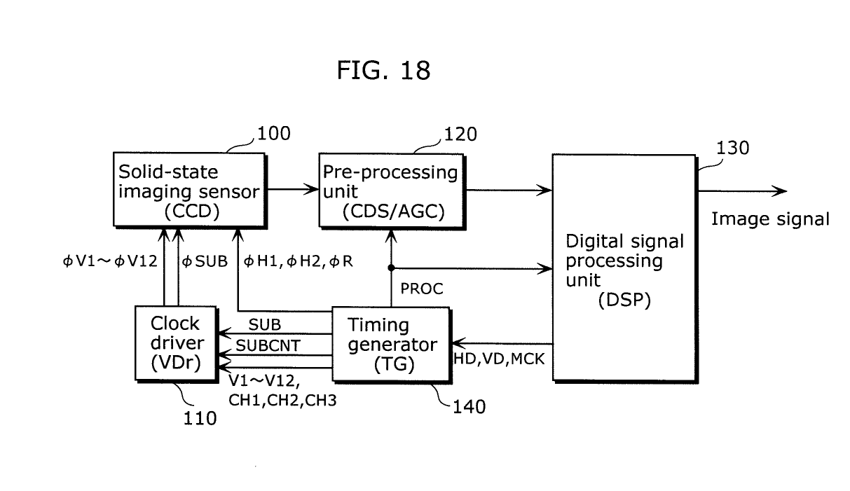

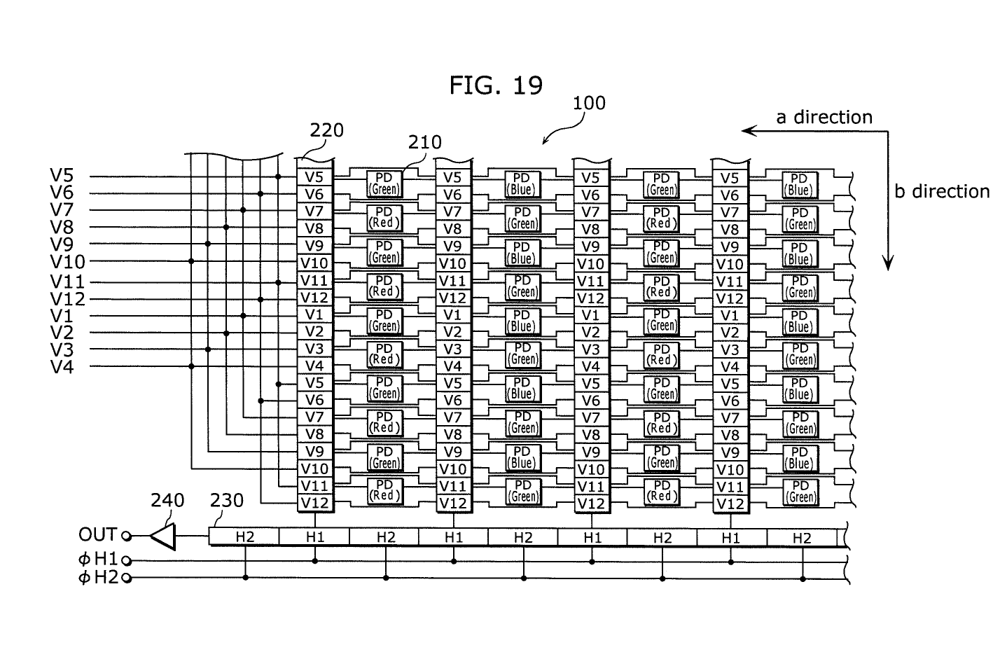

FIG. 18 is a diagram showing a schematic structure of a solid-state imaging device according to the present modification, and FIG. 19 is a diagram showing a detailed structure of a solid-state image sensor 100 according to the present modification.

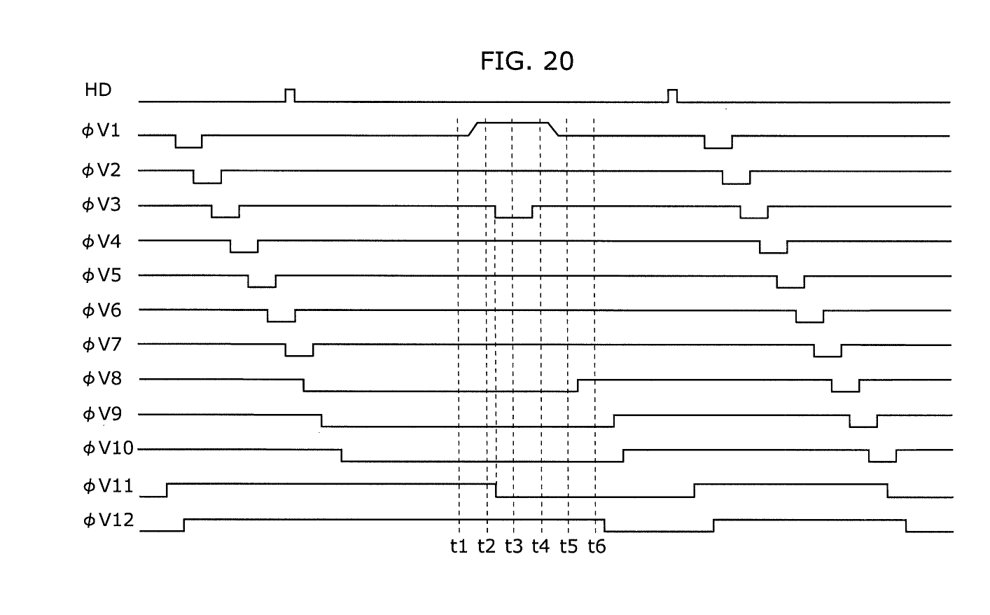

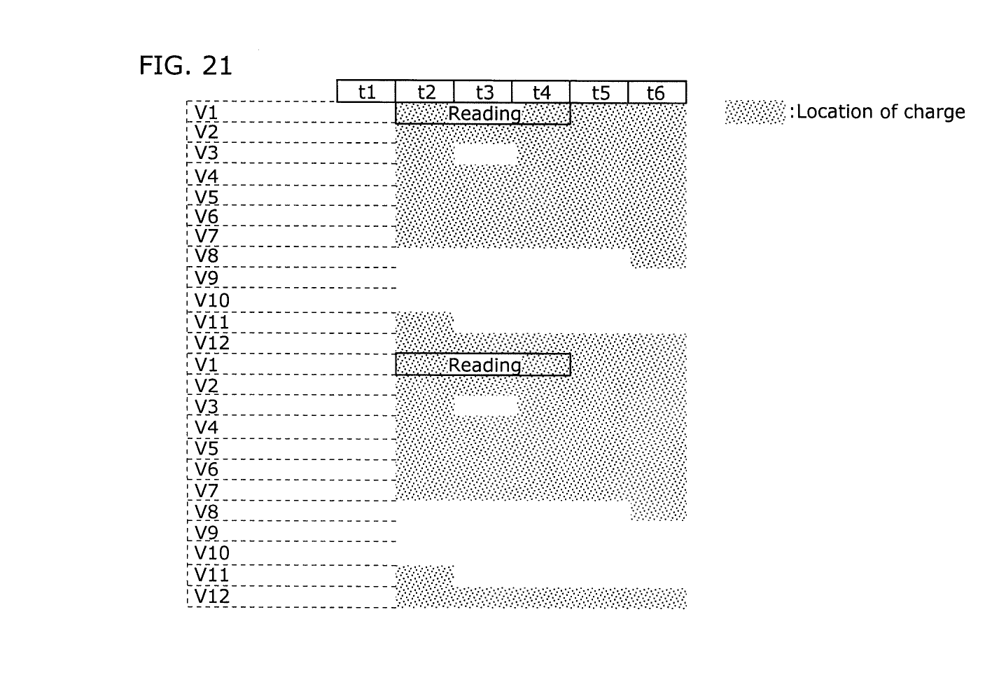

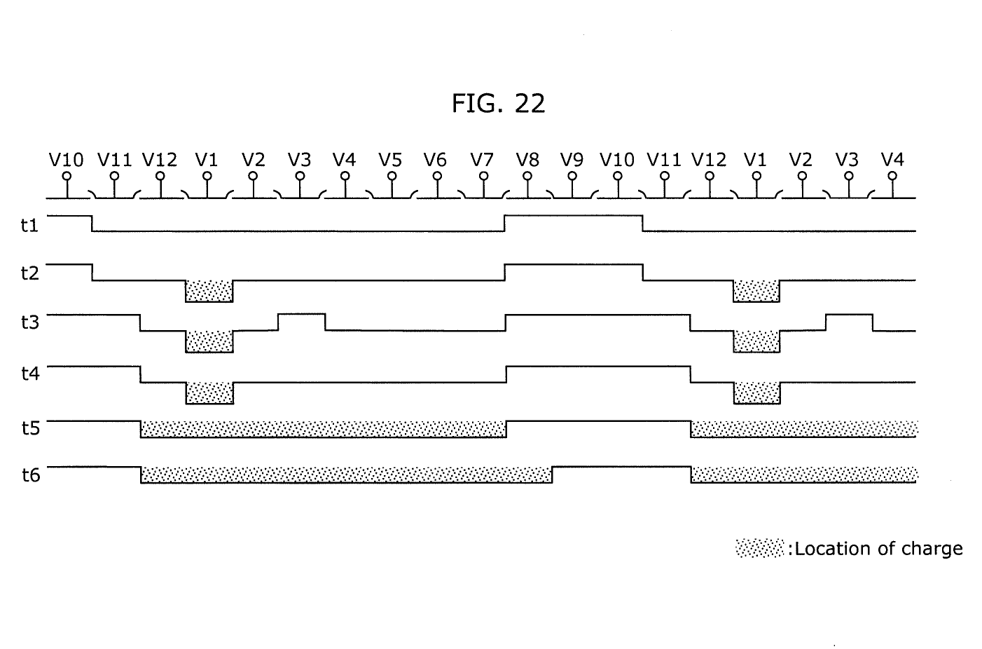

Furthermore, FIGS. 20 to 22 each are a diagram showing a method for transferring a signal charge in a twelve-phase vertical CCD. FIG. 20 is a timing diagram showing the method for transferring, FIG. 21 is a charge transfer conceptual diagram showing the method for transferring, and FIG. 22 is a potential distribution variation diagram showing the method for transferring.

First, FIG. 20 shows that, at a time t1, driving pulses φV8 to φV10 are at a low level, and an electric potential V_{L} is applied to transfer electrodes V8 to V10. As a result, a potential well for accumulating signal charges is formed below transfer electrodes V1 to V7 and V11 and V12.

At a time t2, a driving pulse φV1 is at a high level, and an electric potential V_{H} is applied to a transfer electrode V1. Consequently, a signal charge of the photodiode 210 provided for the transfer electrode V1 is read into below the transfer electrode V1. While the electric potential V_{H} is being applied to the transfer electrode V1, driving pulses φV12 and φV2 are at a middle level and an electric potential V_{M} is applied to both transfer electrodes φV12 and φV2 that are adjacent to the transfer electrode V1. Thus, since a difference in electric potentials between the adjacent transfer electrodes, that is, between the transfer electrode V1 and the transfer electrodes V12 and V2 becomes smaller, a high electric field is not produced on a substrate unlike the technique disclosed by Patent Reference 1, and it is possible to suppress the aged deterioration of the vertical CCD.

At a time t3, driving pulses φV3 and φV11 each are concurrently changed into an electric potential having a reverse polarity with respect to the driving pulse φV1 so as to be at a low level, and electric potentials of transfer electrodes V3 and V11 each are concurrently changed into the electric potential V_{L} having a reverse polarity with respect to the electric potential V_{H}. This can suppress an influence on variation in electric potential below the transfer electrode V1 that contributes to reading a signal charge, and a potential shape below the transfer electrode V1 is changed into a large slope gradually sloping downward from the photodiode 210 to the vertical CCD 220. As a result, a reading residue when reading the signal charge of the photodiode 210 to the vertical CCD 220 can be prevented from occurring.

At a time t4, the driving pulse φV3 is at a middle level, and the electric potential V_{M} is applied to the transfer electrode V3. This further changes the potential shape below the transfer electrode V1 that contributes to reading the signal charge. Consequently, the reading residue when reading the signal charge of the photodiode 210 to the vertical CCD 220 is highly likely to be prevented from occurring.

At a time t5, the driving pulse φV1 is at a middle level, and the electric potential V_{M} is applied to the transfer electrode V1. As a result, the read signal charge is transferred to the potential well below the transfer electrodes V1 to V7 and V12.

At a time t6, the driving pulse φV8 is at a middle level, and the electric potential V_{M} is applied to the transfer electrode V8. Consequently, the read signal charge is transferred to the potential well below the transfer electrodes V1 to V8 and V12.

Moreover, although, in the present modification, in a time period when the high level is applied to the driving pulse φV1, the driving pulses φV3 and φV11 each are changed into the electric potential having the reverse polarity with respect to the driving pulse φV1 so as to be at a low level and the electric potentials of the transfer electrodes V3 and V11 each are changed into the electric potential V_{L} having the reverse polarity with respect to the electric potential V_{H}, the transfer electrode of which electric potential is changed may be a transfer electrode that is not adjacent to the transfer electrode to which the potential V_{M} is applied, and the same effect can be produced even when, for instance, the transfer electrode V5 instead of the transfer electrode V3 is set to the electric potential V_{M}.

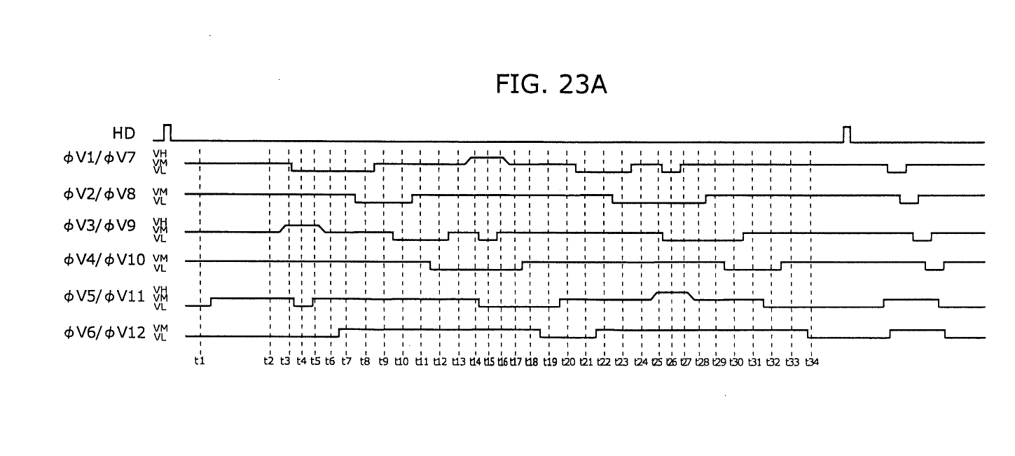

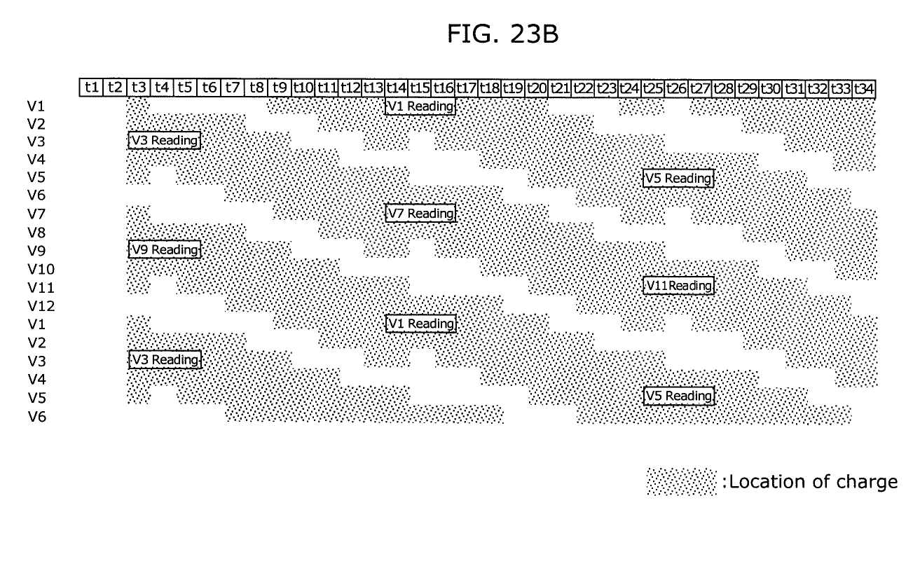

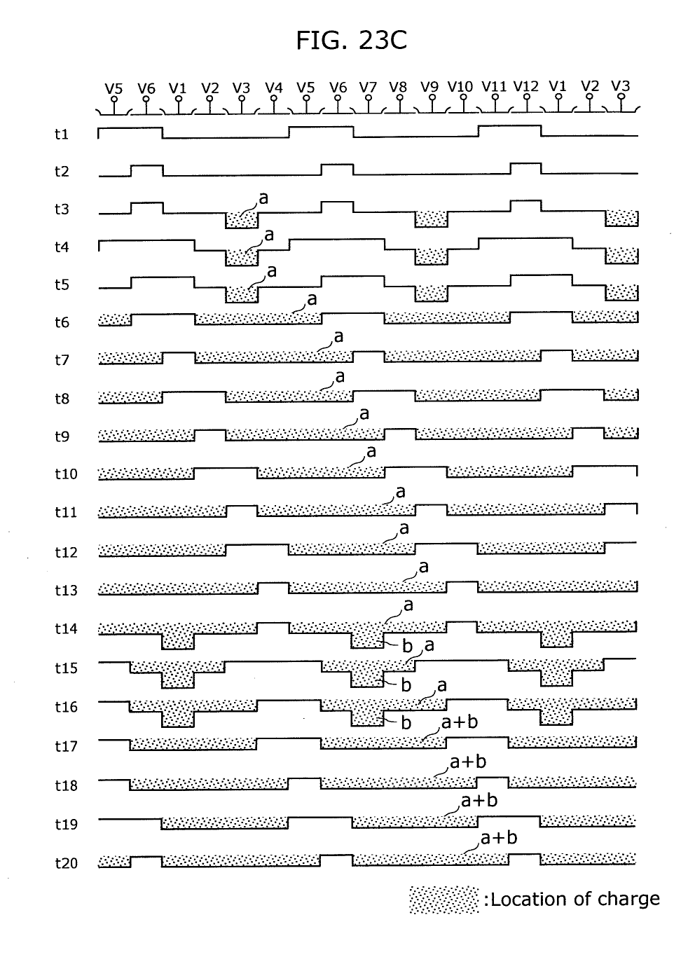

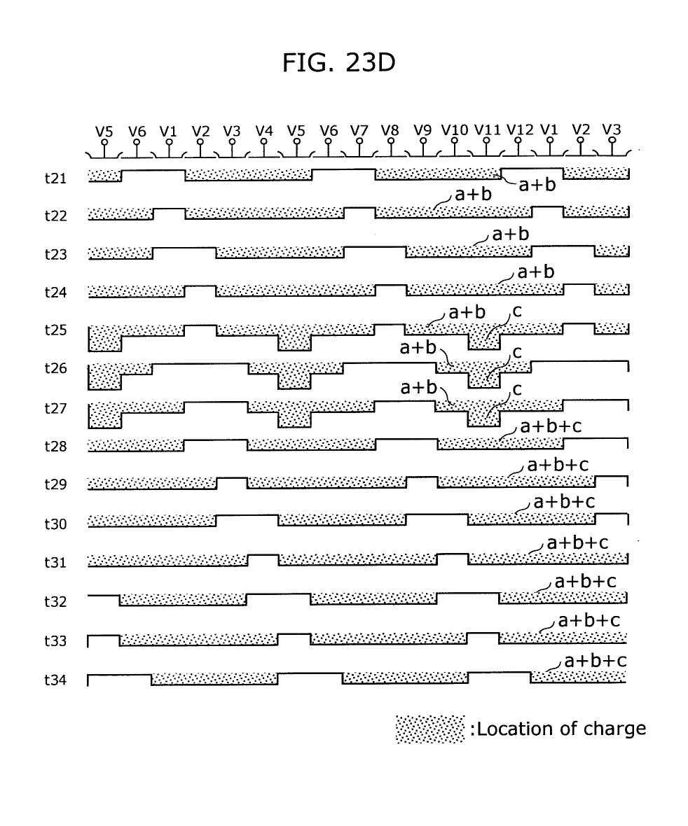

Next, FIGS. 23A to 23D each are a diagram showing signal charge mixture (pixel mixture) in a twelve-phase vertical CCD. FIG. 23A is a timing diagram showing the signal charge mixture, FIG. 23B is a charge mixture transfer conceptual diagram showing the signal charge mixture, and FIGS. 23C and 23D each are a potential distribution variation diagram showing the signal charge mixture.

FIGS. 23A to 23D each show that, in comparison with the method shown in FIGS. 7A to 7D, six types of driving pulses, φV1=φV7, φV2=φV8, φV3=φV9, φV4=φV10, φV5=φV11, φV6=φV12, are applied with driving timing according to the present modification, and the same electric potential is applied to the transfer electrodes V1 and V7. Likewise, the same electric potential is applied to the transfer electrodes V2 and V8, the transfer electrodes V3 and V9, the transfer electrodes V4 and V10, the transfer electrodes V5 and V11, and the transfer electrodes V6 and V12, and this operation is the same as the operation shown in FIGS. 7A to 7D in terms of charge transfer.

It is to be noted that, in the present modification, twelve-phase driving is performed by applying the twelve types of the driving pulses to the vertical CCD when the pixel mixture is not performed (for example, in the case of a driving mode where a still image is captured), and six-phase driving is performed by applying the six types of the driving pulses to the vertical CCD when the pixel mixture is performed (in the case of other modes in which the pixel mixture is performed).

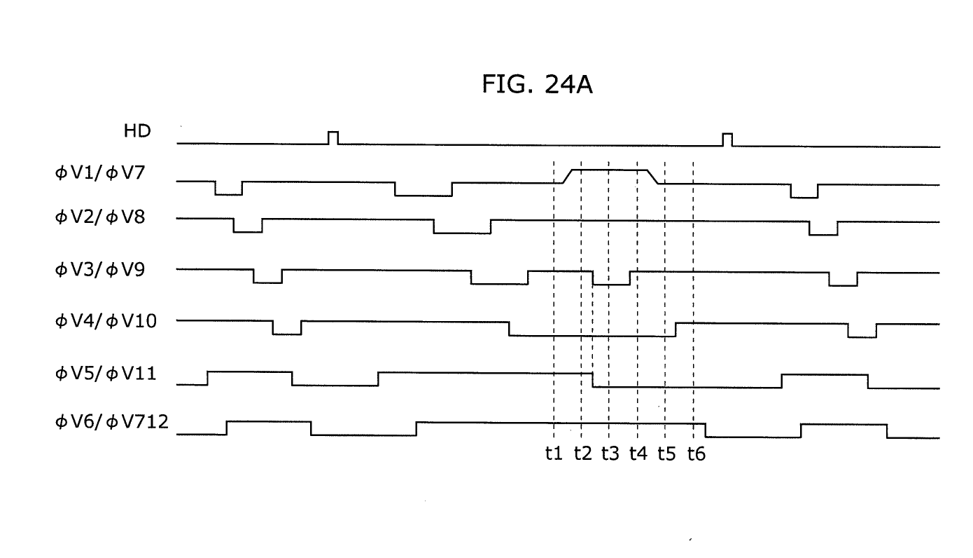

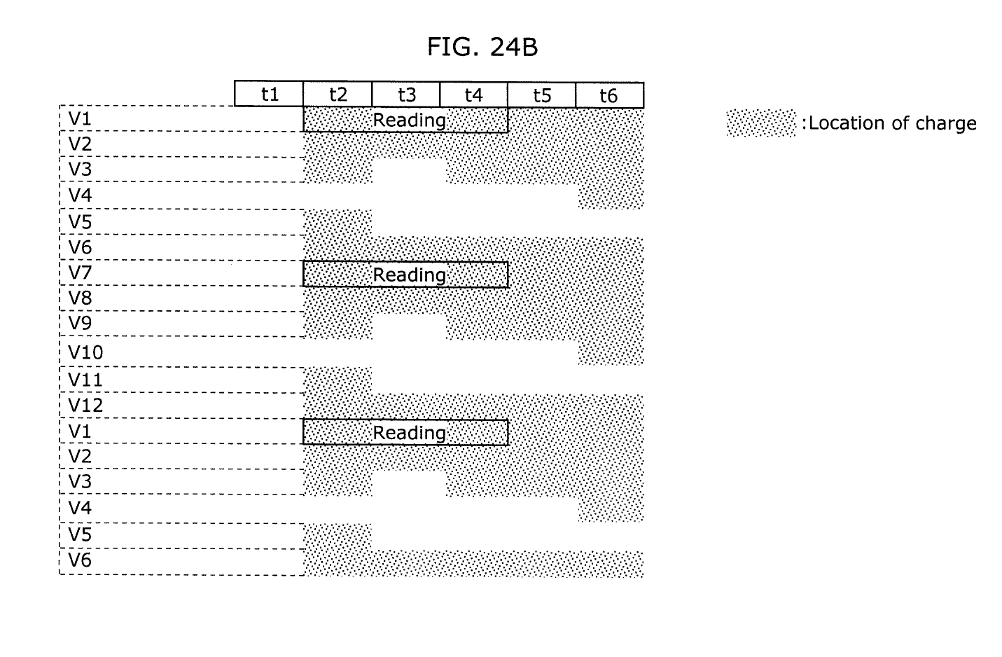

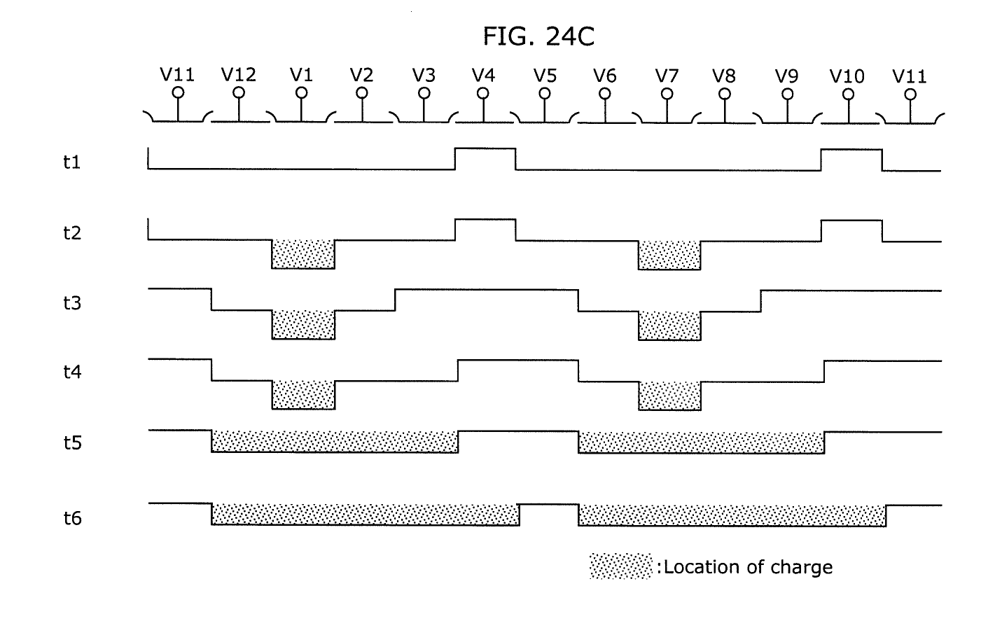

However, as shown in FIGS. 24A to 24C, the six-phase driving may be performed using the six types of the driving pulses when the pixel mixture is not performed. Further, the twelve-phase driving may also be performed using the twelve types of the driving pulses when the pixel mixture is performed. It is to be noted that there are advantages of increasing the transfer capacity of the transfer electrode and further improving the saturation characteristics when the twelve-phase driving is performed.

### Embodiment 3

The following describes a method for driving a solid-state imaging device and a solid-state imaging device according to Embodiment 3 of the present invention.

First, the solid-state imaging device according to the present embodiment has the same structure shown in FIGS. 3 and 4 (FIGS. 18 and 19). The timing generator 140 provides, for the clock driver 110, SUBCNT and SUB to be described later, and further the clock driver 110 for which the signals are provided provides φSUB (SUB pulse) for the solid-state image sensor 100.

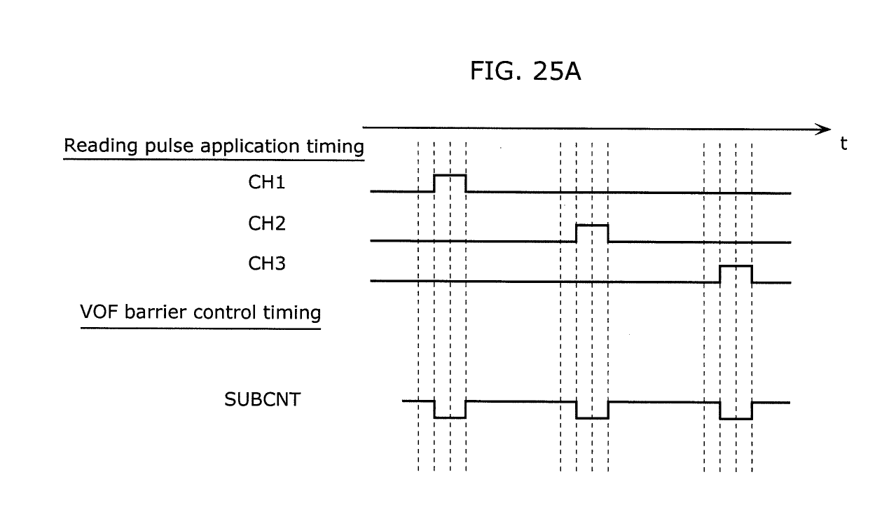

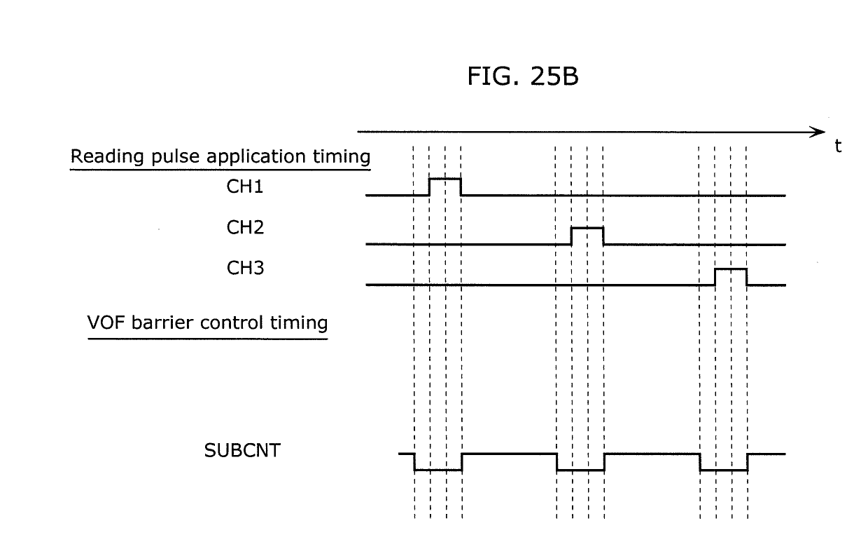

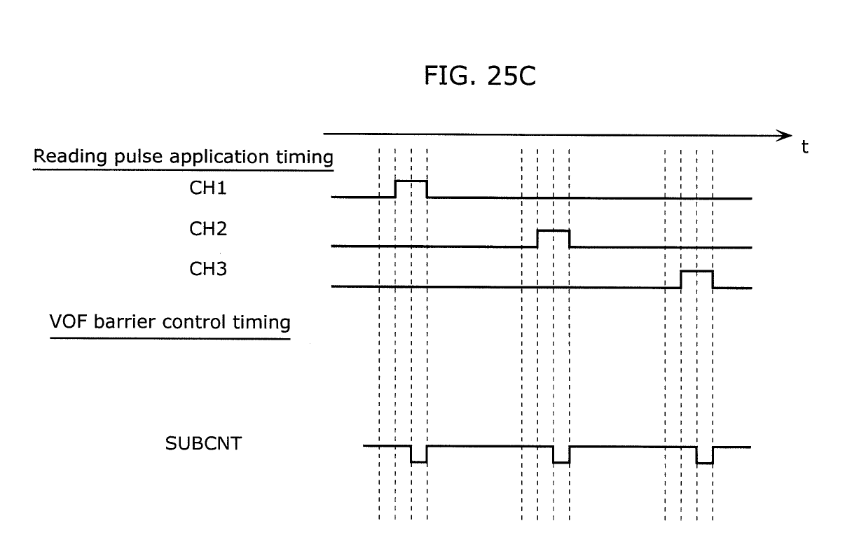

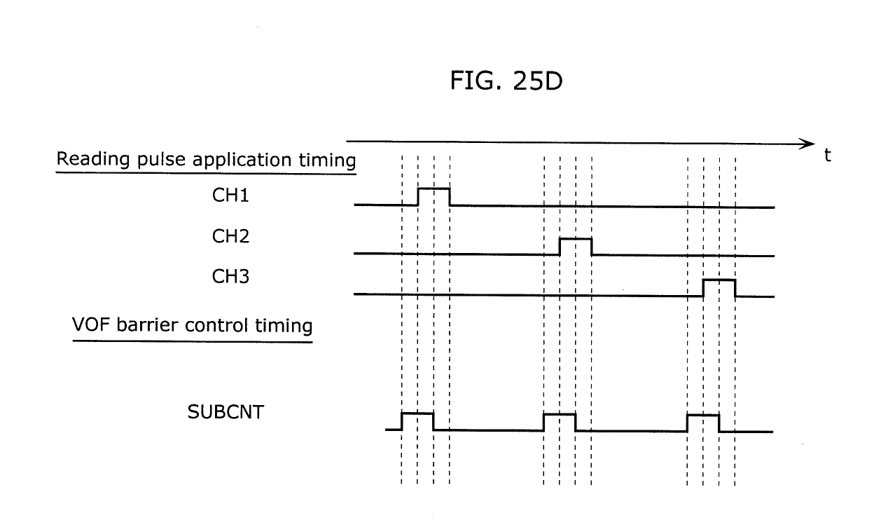

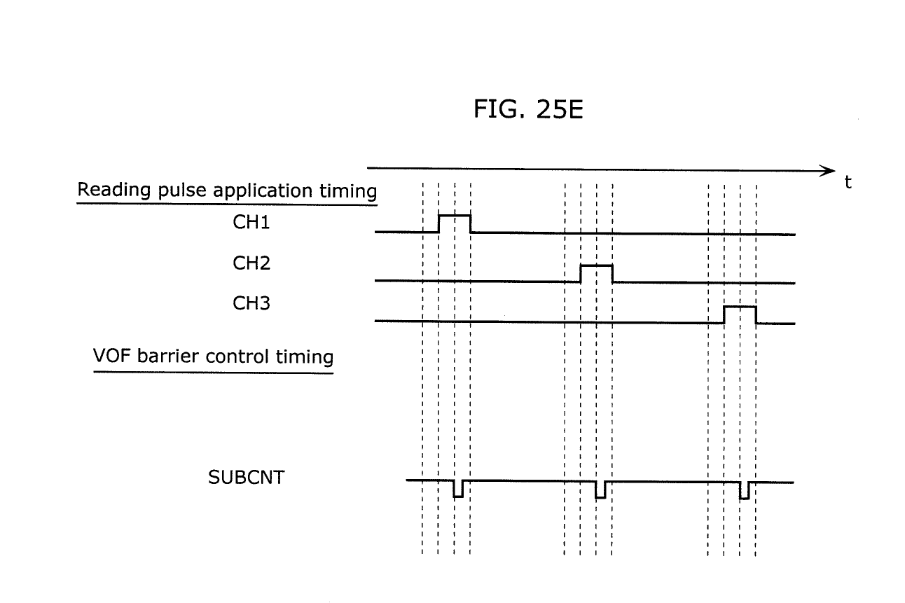

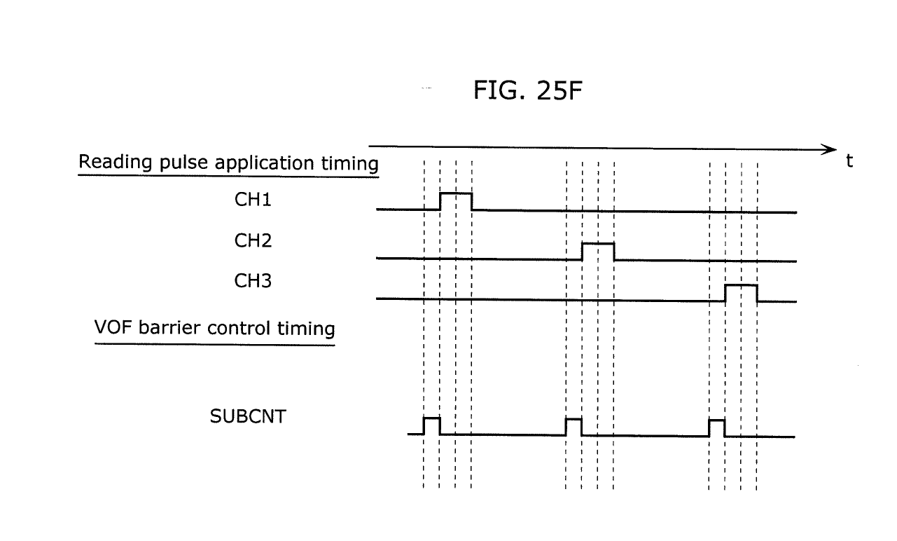

Next, FIG. 25 (FIGS. 25A to 25F) is a timing diagram regarding a reading control signal (hereinafter, CH signal) and a VOF barrier control signal (hereinafter, referred to SUBCNT). It is to be noted that variations of the method for driving the solid-state imaging device according to the present embodiment are merely described here, and any of the variations may be selected for application depending on a desirable purpose.

A VOF barrier is a potential barrier (barrier level) between a vertical over flow drain (substrate side) and a photodiode. Charge capacity of the photodiode increases (A state) when the barrier is elevated, and the charge capacity of the photodiode decreases (A′ state) when the barrier is lowered. Since all charges in the photodiode are discharged into the substrate side when the barrier is lowered extremely, the barrier can be used as a reset function (electric shutter) for the photodiode (B state). A φSUB pulse is generated with SUB, and a signal level at a time of SUB pulse non-application determines a height of the VOF barrier and causes a CCD to be in A state or A′ state. A signal level at a time of φSUB pulse application causes the CCD to be in B state. The VOF barrier is lowest (B state) when the φSUB pulse is applied. A DC level of a φSUB signal in a state where the φSUB pulse is not raised is controlled inside the clock driver 110 with SUBCNT. Here, the CCD is either in A state or A′ state. The CCD in a state where the φSUB pulse is raised is in B state. This has nothing to do with a state (either A state or A′ state) where the pulse has not raised yet.

SUBCNT is provided by the timing generator 140, and is a control logic signal (a signal for controlling the signal level (≈DC offset amount) at the time of the φSUB pulse non-application) to be inputted to the clock driver 110. Specifically, the CCD is in A′ state when φSUB (at the time of the pulse application) is at the time of “H” level SUBCNT, and the CCD is in A state when φSUB (at the time of the pulse non-application) is at the time of “L” level SUBCNT.

CH1 to CH3 each are a control logic signal for causing an electric potential of a transfer electrode to be the first electric potential. In the present description, CH1 to CH3 each are the control logic signal for causing the electric potential of the transfer electrode to be the first electric potential at a time of “H” logic, and are the control logic signal for causing the electric potential of the transfer electrode to be other than the first electric potential (second electric potential or third electric potential) at a time of “L” logic. It is to be noted that states of V1 to V6 signals provided from the TG 140 to the VDr 110 determine whether an electric potential of a transfer electrode is the second electric potential or the third electric potential at the time of “L” logic. Moreover, when this is corresponded to the reading signal provision timing shown in FIG. 7A, CH1 corresponds to reading of φV3, CH2 corresponds to reading of φV1, and CH3 corresponds to φV5.

In the method for driving the solid-state imaging device according to the present embodiment shown in FIG. 25 (FIGS. 25A to 25F), control for lowering the VOF barrier is performed at the time of “H” logic, and control for elevating the VOF barrier is performed at the time of “L” logic. It is to be noted that photodiode capacity increases when the VOF barrier is high, and the photodiode capacity decreases when the VOF barrier is low.

It is to be noted that a commonly-used VOF barrier control method causes SUBCNT to be “H” in an initial state, to maintain “H” during a series of reading operation, and to be “H” in a final state.

On the other hand, as shown in FIG. 25A, performed with VOF barrier control timing of the present embodiment is control which causes SUBCNT to be “H” in an initial state, to be “L” concurrently with raising each of CH signals (this is called A1 control), to maintain “L” in a time period when each CH signal is “H” (this is called A2 control), to raise to “H” concurrently with lowering each CH signal (this is called A3 control), and to be “H” in a final sate after repeating A1 to A3 control as many times as the number of reading.

The method for driving the solid-state imaging device according to the present embodiment makes it possible to reduce, by the above driving, charge dissipation into an adjacent pixel of a photodiode caused by a reading operation while removing a reading residue, and to prevent, by a reading operation for a specific photodiode, a decrease in photodiode saturation caused by dissipation (dissipation caused by a charge crossing a potential barrier between a vertical overflow drain and a photodiode) of a charge of a pixel not to be read which is adjacent to the pixel to be read, when there are many charges in the photodiode.

Furthermore, it is possible to reduce the charge dissipation in the pixel not to be read caused by each of reading operations, by increasing capacity of all photodiodes by causing SUBCNT to be “L” in a time period when each CH signal is “H”.

Moreover, it is possible to prevent the maximum potential of the photodiode from deepening at a time of signal reading and saturation characteristics from degrading, and to reduce a reading voltage.

In other words, since the reading residue when reading the signal charge of the photodiode 210 to the vertical CCD 220 is prevented from occurring, the method for driving the solid-state imaging device according to the present embodiment makes it possible to reduce the reading voltage. When the reading residue occurs, an image defect such as surface roughness of an image occurs because a variation in an amount of signal charge read for each of the photodiodes 210 occurs. Therefore, preventing the reading residue from occurring can lead to prevention of the image defect. Furthermore, since the reading residue when reading the signal charge of the photodiode 210 to the vertical CCD 220 is highly likely to be prevented from occurring, it is possible to significantly reduce the reading voltage. Moreover, even when pixels are refined along with miniaturization of a solid-state imaging device and a transfer capability of a vertical CCD is reduced, a sufficient transfer capability can be ensured, and it is possible to achieve a balance between the miniaturization of the solid-state imaging device and enhancement of image characteristics such as sensitivity characteristics, smear characteristics, and saturation characteristics. Furthermore, it is possible to prevent the notable image defect such as the surface roughness of the image in a solid-state image sensor in which wiring that provides a driving pulse to a transfer electrode has a shunt wiring structure.

Moreover, it is possible to combine the method for driving the solid-state imaging device and the solid-state imaging device according to the present embodiment with the method for driving the solid-state imaging device and the solid-state imaging device according to Embodiments 1 and 2 of the present invention. Since this further prevents the reading residue when reading the signal charge of the photodiode 210 to the vertical CCD 220 from occurring, it is possible to reduce the reading voltage and further prevent the image defect such as the surface roughness of the image. Furthermore, since the reading residue when reading the signal charge of the photodiode 210 to the vertical CCD 220 is highly likely to be prevented from occurring, it is further possible to significantly reduce the reading voltage. Moreover, even when the pixels are refined along with the miniaturization of the solid-state imaging device and the transfer capability of the vertical CCD is reduced, the sufficient transfer capability can be ensured, and it is possible to achieve the balance between the miniaturization of the solid-state imaging device and the enhancement of the image characteristics such as the sensitivity characteristics, the smear characteristics, and the saturation characteristics. Furthermore, it is further possible to prevent the image defect such as the notable surface roughness of the image in the solid-state image sensor in which the wiring that provides the driving pulse to the transfer electrode has the shunt wiring structure.

It is to be noted that, as shown in FIG. 25B, when considering a case where a waveform for lowering SUBCNT is delayed inside a CCD in terms of control, the method for driving the solid-state imaging device according to the present embodiment makes it possible to perform control which causes SUBCNT to be “H” in an initiate state, to be “L” prior to a raising operation for each of CH signals (this is called B1 control), to maintain “L” in a time period when each CH signal is “H” (this is called B2 control), to raise to “H” concurrently with lowering each CH signal (this is called B3 control), and to be “H” in a final state after repeating B1 to B3 control as many times as the number of reading.

Moreover, as shown in FIG. 25C, in order to enhance an effect of removing the reading residue, the method for driving the solid-state imaging device according to the present embodiment makes it possible to perform control which causes SUBCNT to be “H” in an initial state, to lower to “L” in a time period when each of CH signals is “H” (this is called C1 control), to have a time period when SUBCNT is “L” in the time period when each CH signal is “H” (this is called C2 control), to raise to “H” concurrently with lowering each CH signal (this is called C3 control), and to be “H” in a final state after repeating C1 to C3 controls as many times as the number of reading.

Furthermore, as shown in FIG. 25D, when ensuring sufficient sensitivity at a time of using a high-speed shutter while removing the reading residue, the method for driving the solid-state imaging device according to the present embodiment makes it possible to perform control which causes SUBCNT to be “L” in an initial state, to be “H” prior to a raising operation for each of CH signals (this is called D1 control), to lower to “L” in a time period when each CH signal is “H” (this is called D2 control), to have a time period when SUBCNT is “L” in the time period when each CH signal is “H” (this is called D3 control), and to be “L” in a final state after repeating D1 to D3 control as many times as the number of reading.

Moreover, as shown in FIG. 25E, when appropriately controlling an amount of signal at a time of high intensity light incidence while removing the reading residue, the method for driving the solid-state imaging device according to the present embodiment makes it possible to perform control which causes SUBCNT to be “H” in an initial state, to lower to “L” in a time period when each of CH signals is “H” (this is called El control), to have a time period when SUBCNT is “L” in the time period when each CH signal is “H” (this is called E2 control), to be “H” prior to a lowering operation for each CH signal (this is called E3 control), and to be “H” in a final state after repeating E1 to E3 control as many times as the number of reading.

Furthermore, as shown in FIG. 25F, when ensuring sufficient sensitivity at a time of using a high-speed shutter while removing the reading residue and producing an effect of reducing charge dissipation of a photodiode prone to be caused by an adjacent pixel reading operation, the method for driving the solid-state imaging device according to the present embodiment makes it possible to perform control which causes SUBCNT to be “L” in an initial state, to be “H” prior to a raising operation for each of CH signals (this is called F1 control), to lower to “L” concurrently with a raising operation for each CH signal to “H” (this is called F2 control), and to be “L” in a final state after repeating F1 to F2 control as many times as the number of reading (this is called F3 control).

### INDUSTRIAL APPLICABILITY

The present invention can be applied to the methods for driving the solid-state imaging device, and in particular to the method for driving the CCD solid-state imaging device.

1. A method for driving a solid-state imaging device which includes photodiodes arranged in columns and rows and vertical transfer units each of which is provided for a corresponding one of the columns of the photodiodes and includes transfer electrodes, said method comprising:
reading a signal charge from each of the photodiodes by setting an electric potential of one of the transfer electrodes to a first electric potential; and
transferring, in a column direction, the read signal charge by applying, to each of the transfer electrodes, a driving pulse having a second electric potential and a third electric potential, the second electric potential being lower than the first electric potential, and the third electric potential being lower than the second electric potential,
wherein, in said reading, while the first electric potential is being applied, an electric potential of a transfer electrode that is adjacent to the transfer electrode having the first electric potential is set to the second electric potential, and an electric potential of a transfer electrode that is not adjacent to the transfer electrode having the first electric potential is changed either from the second electric potential to the third electric potential or from the third electric potential to the second electric potential.

2. The method for driving the solid-state imaging device according to claim 1,
wherein wiring that provides the driving pulse to each transfer electrode has a shunt wiring structure.

3. The method for driving the solid-state imaging device according to claim 1,
wherein the transfer electrode having the first electric potential has a larger area than the transfer electrode that is adjacent to the transfer electrode having the first electric potential.

4. The method for driving the solid-state imaging device according to claim 1,
wherein, in said transferring, a five- or more phase driving pulse is applied to each transfer electrode.

5. The method for driving the solid-state imaging device according to claim 1,
wherein each transfer electrode includes a twelve-phase vertical CCD, and
in said transferring, each transfer electrode is driven by applying a twelve-phase driving pulse in a driving mode in which a still image is captured, and each transfer electrode is driven by applying a six-phase driving pulse in a mode in which pixel mixture is performed.

6. The method for driving the solid-state imaging device according to claim 1,
wherein, in said reading, the electric potential of the transfer electrode that is not adjacent to the transfer electrode having the first electric potential is changed into an electric potential having a reverse polarity with respect to the first electric potential, while the signal charge is being read.

7. The method for driving the solid-state imaging device according to claim 1,
wherein a potential barrier level between a vertical overflow drain and a photodiode is changed two or more times during said reading or before and after said reading.

8. The method for driving the solid-state imaging device according to claim 1,
wherein, in said reading, electric potentials of two transfer electrodes that are not adjacent to the transfer electrode having the first electric potential are changed while the signal charge is being read.

9. The method for driving the solid-state imaging device according to claim 8,
wherein, in said reading, the electric potentials of the two transfer electrodes that are not adjacent to the transfer electrode having the first electric potential are concurrently changed into a reverse polarity with respect to the first electric potential while the signal charge is being read.

10. The method for driving the solid-state imaging device according to claim 8,
wherein, in said reading, the electric potentials of the two transfer electrodes that are not adjacent to the transfer electrode having the first electric potential are changed, and then one of the two changed electric potentials of the transfer electrodes is restored, while the signal charge is being read.

11. The method for driving the solid-state imaging device according to claim 1,
wherein, in said reading, an electric potential of a predetermined transfer electrode that is not adjacent to the transfer electrode having the first electric potential is changed two times while the signal charge is being read.

12. A solid-state imaging device comprising:
photodiodes arranged in columns and rows;
vertical transfer units each of which is provided for a corresponding one of the columns of said photodiodes and includes transfer electrodes; and
a transfer control unit configured to: read a signal charge from each of said photodiodes by setting an electric potential of one of the transfer electrodes to a first electric potential; transfer, in a column direction, the read signal charge by applying, to each of the transfer electrodes, a driving pulse having a second electric potential and a third electric potential; and, in the reading of the signal charge, while the first electric potential is being applied, set an electric potential of a transfer electrode that is adjacent to the transfer electrode having the first electric potential, to the second electric potential, and change, either from the second electric potential to the third electric potential or from the third electric potential to the second electric potential, an electric potential of a transfer electrode that is not adjacent to the transfer electrode having the first electric potential, the second electric potential being lower than the first electric potential, and the third electric potential being lower than the second electric potential.

13. The solid-state imaging device according to claim 12,
wherein wiring that provides the driving pulse to each transfer electrode has a shunt wiring structure.

14. The solid-state imaging device according to claim 12,
wherein the transfer electrode having the first electric potential has a larger area than the transfer electrode that is adjacent to the transfer electrode having the first electric potential.
